(19) United States
(12) Patent Application Publication
(10) Pub. No.: US 2024/0216193 A1
(43) Pub. Date: Jul. 4, 2024

(54) Patient Transport Apparatus Having Track Assembly Brace

(71) Applicant: Stryker Corporation, Kalamazoo, MI (US)

(72) Inventors: Sashank Manohar, Portage, MI (US); Blake Macias, Ortonville, MI (US); Rex Allen Powers, JR., Kalamazoo, MI (US)

(73) Assignee: Stryker Corporation, Kalamazoo, MI (US)

(21) Appl. No.: 18/191,301

(22) Filed: Mar. 28, 2023

Related U.S. Application Data
(60) Provisional application No. 63/436,268, filed on Dec. 30, 2022.

(51) Int. Cl. A61G 5/06

(52) U.S. Cl. CPC A61G 5/061; A61G 5/066

(57) ABSTRACT

A patient transport apparatus for transporting a patient along stairs. The patient transport apparatus includes a support structure including a rear support assembly and a track assembly extending from the support structure. The track assembly includes a rail extending between a first and second rail ends. The track assembly further includes a roller adjacent to the first rail end, a motor supporting a pulley adjacent to the second rail end, and a belt supported in engagement with the roller and the pulley. The track assembly further includes a lateral brace operatively attached to the rail and defining a brace configured to abut at least a portion of the belt to retain the belt in engagement with the roller for limiting lateral movement of the belt relative to the rail occurring in response to force acting on the belt between stairs and the roller during operation of the motor.

### CROSS-REFERENCE TO RELATED APPLICATION

The subject patent application claims priority to and all the benefits of U.S. Provisional Patent Application No. 63/436,268 filed on Dec. 30, 2022, the disclosure of which is hereby incorporated by reference in its entirety.

### BACKGROUND

In various environments, persons with limited mobility may have difficulty traversing stairs without assistance. In certain emergency situations, traversing stairs may be the only viable option for exiting a building. Here, in order for a caregiver to transport a patient along stairs in a safe and controlled manner, a stair chair or evacuation chair may be utilized to facilitate safe stair traversal. Stair chairs are adapted to transport seated patients either up or down flights of stairs, with two caregivers typically supporting, stabilizing, or otherwise carrying the stair chair with the patient supported thereon.

Certain types of conventional stair chairs include a motor that powers a belt about a track to assist the caregiver ascend and/or descend stairs with the patient seated in the stair chair. However, depending on the specific configuration of the conventional stair chair and the circumstances of the use of the chair, the belt may be forced from, and become unaligned with, the track thereby limiting the assistance provided to the caregiver as the caregiver is actively ascending or descending stairs with the patient supported in the conventional chair.

A patient transport apparatus designed to overcome the aforementioned challenge is desired.

### SUMMARY

The present disclosure includes, in one aspect, a patient transport apparatus operable by a user for transporting a patient along stairs. The patient transport apparatus includes a support structure including a rear support assembly having a rear upright defining a support channel. The patient transport apparatus also includes a seat section and a back section coupled to the support structure for supporting the patient and a track assembly extending from the support structure. The track assembly includes a rail extending between a first rail end and a second rail end. The track assembly further includes a roller supported for rotation adjacent to the first rail end, and a motor supporting a pulley for rotation adjacent to the second rail end. The track assembly further includes a belt supported in engagement with the roller and the pulley and arranged for movement relative to the rail in response to torque generated by the motor. Additionally, the track assembly includes a lateral brace operatively attached to the rail and defining a brace. The brace is configured to abut at least a portion of the belt to retain the belt in engagement with the roller for limiting lateral movement of the belt relative to the rail occurring in response to force acting on the belt between stairs and the roller during operation of the motor.

The present disclosure includes, in another aspect, a patient transport apparatus operable by a user for transporting a patient along stairs. The patient transport apparatus includes a support structure including a rear support assembly having a rear upright defining a support channel. The patient transport apparatus also includes a seat section and a back section coupled to the support structure for supporting the patient and a track assembly extending from the support structure. The track assembly includes a rail extending between a first rail end and a second rail end. The track assembly further includes a roller supported for rotation adjacent to the first rail end, and a motor supporting a pulley for rotation adjacent to the second rail end. The track assembly further includes a belt supported in engagement with the roller and the pulley and arranged for movement relative to the rail in response to torque generated by the motor. Additionally, the track assembly includes a lateral brace operatively attached to the rail and defining a right brace and a left brace, with the left brace and the right brace independently configured to abut at least a portion of the belt to retain the belt in engagement with the roller for limiting lateral movement of the belt relative to the rail occurring in response to force acting on the belt between stairs and the roller during operation of the motor.

### BRIEF DESCRIPTION OF THE DRAWINGS

Other advantages of the present invention will be readily appreciated as the same becomes better understood by reference to the following detailed description when considered in connection with the accompanying drawings.

FIG. 1 is a front perspective view of a patient transport apparatus according to the present disclosure, shown arranged in a chair configuration for supporting a patient for transport along a floor surface, and shown having a track assembly disposed in a retracted position, and a handle assembly disposed in a collapsed position.

FIG. 2 is another front perspective view of the patient transport apparatus of FIG. 1, shown arranged in a stair configuration for supporting the patient for transport along stairs, and shown with the track assembly disposed in a deployed position, and with the handle assembly disposed in an extended position.

FIG. 3 is a rear perspective view of the patient transport apparatus of FIGS. 1-2, shown arranged in the stair configuration as depicted in FIG. 2, and shown having an extension lock mechanism, a folding lock mechanism, and a deployment lock mechanism.

FIG. 4 is a partial schematic view of a control system of the patient transport apparatus of FIGS. 1-3, shown with a controller disposed in communication with a battery, a user interface, and a drive system.

FIG. 5 is a right-side plan view of the patient transport apparatus of FIGS. 1-4, shown arranged in a stowed configuration maintained by the folding lock mechanism.

FIG. 6A is another right-side plan view of the patient transport apparatus arranged in the chair configuration and with a handle assembly in a collapsed position.

FIG. 6B is another right-side plan view of the patient transport apparatus arranged in the chair configuration and with the handle assembly in an intermediate position.

FIG. 6C is another right-side plan view of the patient transport apparatus arranged in the chair configuration and with the handle assembly in an extended position

FIG. 7A is a partial rear perspective view of the patient transport apparatus of FIGS. 1-6B, shown arranged in the chair configuration as depicted in FIG. 1, with the deployment lock mechanism shown retaining the track assembly in the retracted position.

FIG. 7B is another partial rear perspective view of the patient transport apparatus of FIG. 7A, shown arranged in the stair configuration as depicted in FIGS. 2-3, with the deployment lock mechanism shown retaining the track assembly in the deployed position.

FIG. 8 is a rear view of the back side of the patient transport apparatus of FIG. 1 depicting the user interface.

FIG. 9A is a right-side plan view of the patient transport apparatus of FIG. 1, shown supporting a patient in the chair configuration on a floor surface adjacent to stairs, and shown with a first caregiver engaging a pivoting handle assembly.

FIG. 9B is another right-side plan view of the patient transport apparatus of FIG. 9A, shown with the first caregiver having engaged the deployment lock mechanism to move the track assembly out of the retracted position and a second caregiver engaging a front handle assembly in an extended position.

FIG. 9C is another right-side plan view of the patient transport apparatus of FIG. 9B, shown having moved towards the stairs for descent while supported by the first and second caregivers.

FIG. 9D is another right-side plan view of the patient transport apparatus of FIG. 9C, shown having moved initially down the stairs for descent to bring a belt of the track assembly into contact with the stairs while still supported by the first and second caregivers.

FIG. 9E is another right-side plan view of the patient transport apparatus of FIG. 9D, shown with the belt of the track assembly in contact with the stairs while still supported by the first and second caregivers.

FIG. 9F is another right-side plan view of the patient transport apparatus of FIG. 9D, shown with the belt of the track assembly in contact with the stairs while still supported by the first and second caregivers and with first.

FIG. 10 is a top perspective view of the handle assembly spaced from a first and second rear upright of the patient transport apparatus.

FIG. 11 is a perspective view of two track assemblies of the patient transport apparatus.

FIG. 12 is a perspective view first rail ends of two track assemblies.

FIG. 13 is a simplified perspective view of the track assembly.

FIG. 14 is a perspective view of a lateral brace coupled to a rail about a belt.

FIG. 15 is another perspective view of the lateral brace coupled to the rail about the belt.

FIG. 16 is another perspective view of the lateral brace including a left brace and a right brace coupled to the rail about the belt.

FIG. 17 is another perspective view of the lateral brace including the left brace and the right brace coupled to the rail about the belt.

FIG. 18 is a perspective view of a mid-brace coupled to the rail of the track assembly.

### DETAILED DESCRIPTION

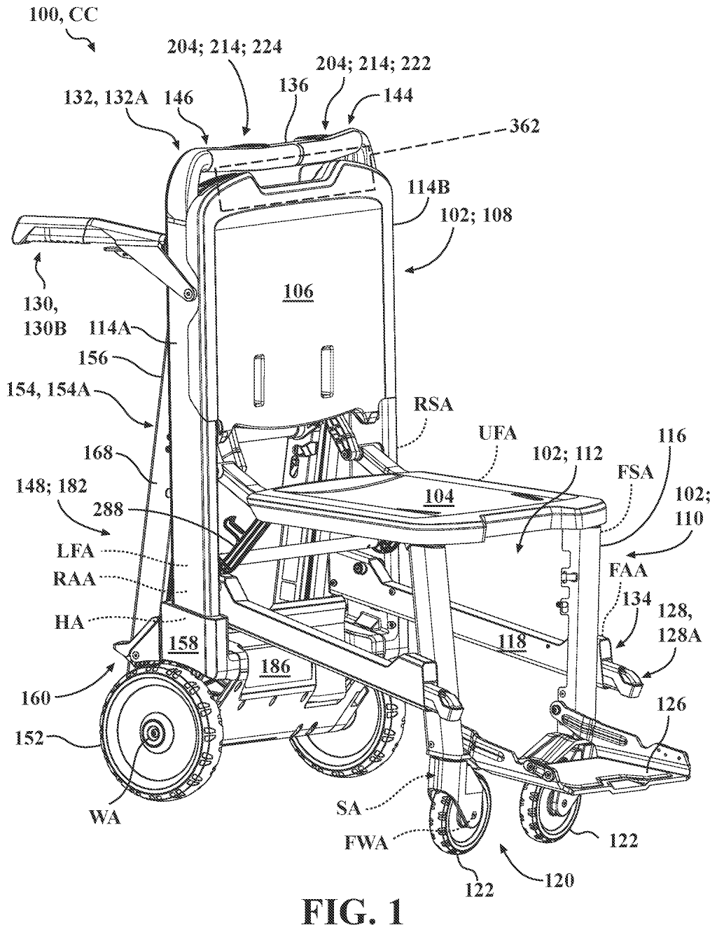

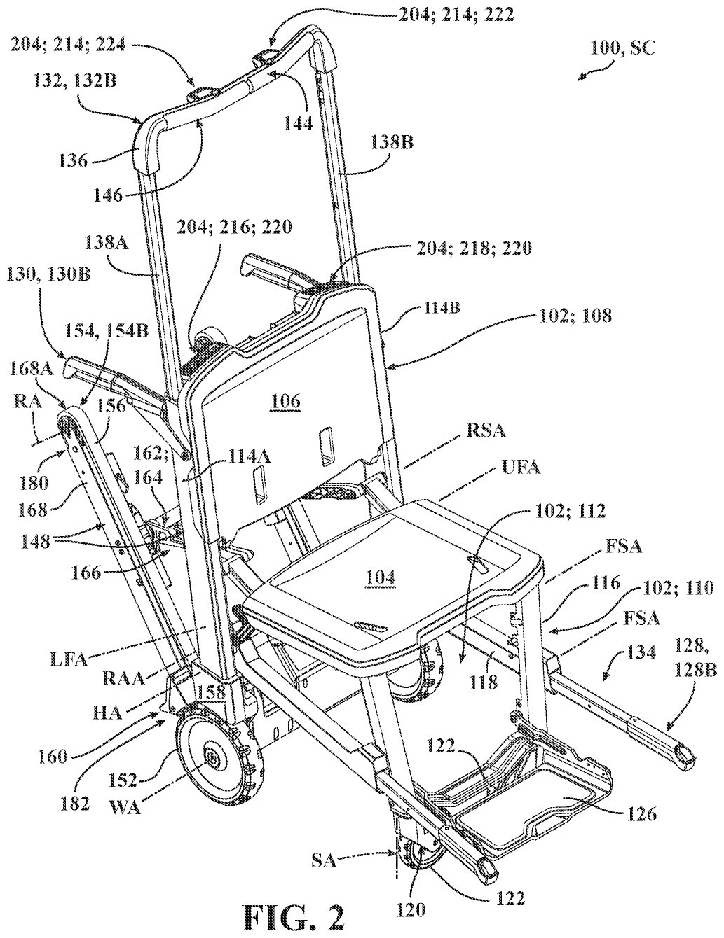

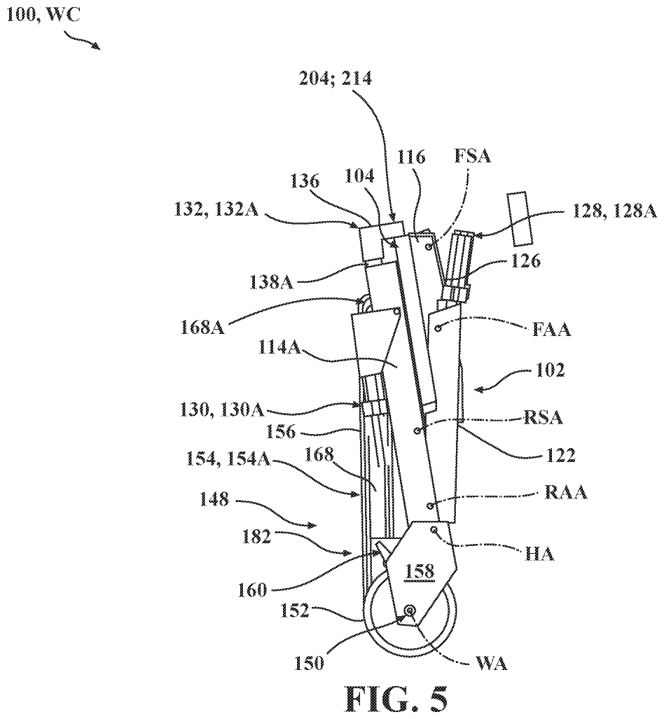

Referring now to the drawings, wherein like numerals indicate like parts throughout the several views, the present disclosure is generally directed toward a patient transport apparatus 100 configured to allow one or more caregivers to transport a patient. To this end, the patient transport apparatus 100 is realized as a “stair chair” which can be operated in a chair configuration CC (see FIG. 1) to transport the patient across ground or floor surfaces FS (e.g., pavement, hallways, and the like), as well as in a stair configuration SC (see FIG. 2) to transport the patient along stairs ST. As will be appreciated from the subsequent description below, the patient transport apparatus 100 of the present disclosure is also configured to be operable in a stowed configuration WC (see FIG. 5) when not being utilized to transport patients (e.g., for storage in an ambulance).

As is best shown in FIG. 1, the patient transport apparatus 100 comprises a support structure 102 to which a seat section 104 and a back section 106 are operatively attached. The seat section 104 and the back section 106 are each shaped and arranged to provide support to the patient during transport. The support structure 102 generally includes a rear support assembly 108, a front support assembly 110, and an intermediate support assembly 112. The back section 106 is coupled to the rear support assembly 108 for concurrent movement. To this end, the rear support assembly 108 comprises a first rear upright 114A arranged on a first side of the rear support assembly 108. The rear support assembly 108 may further comprise a second read upright 114B on a second side of the rear support assembly 108, opposite the first side. The rear uprights 114A, 114B may extend generally vertically and are secured to the back section 106 such as with fasteners (not shown in detail).

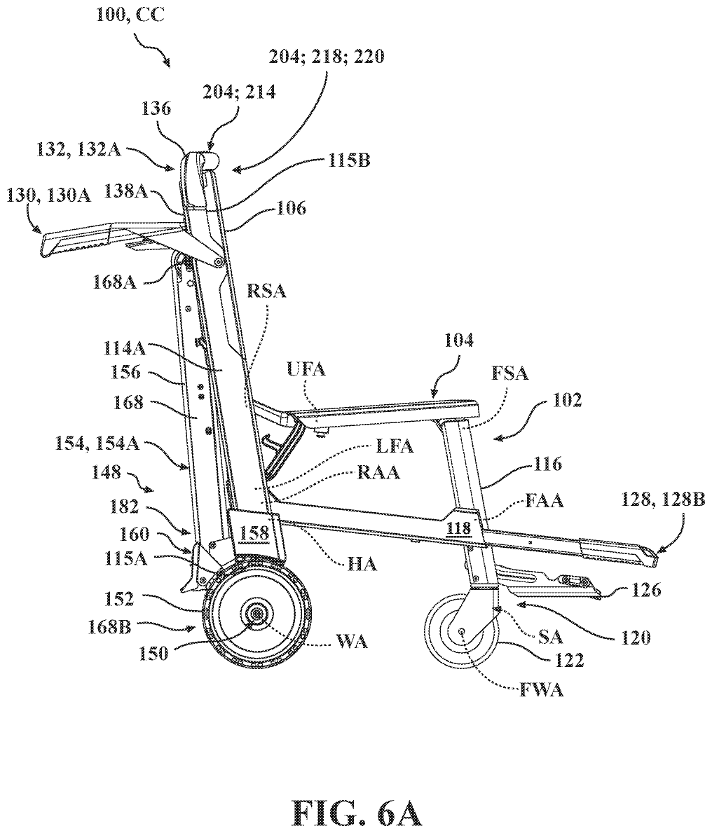

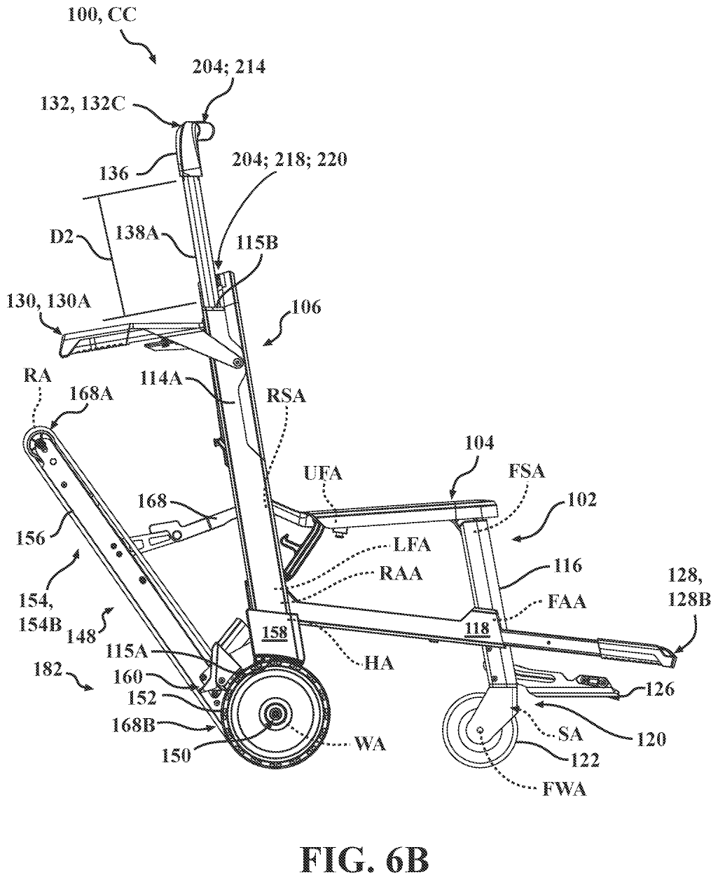

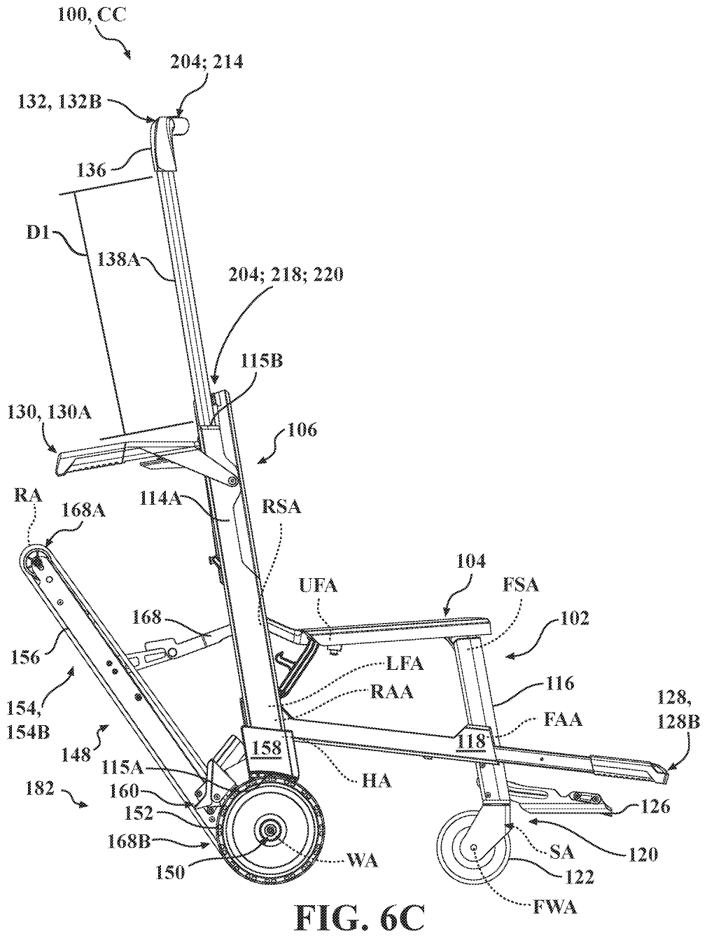

The intermediate support assembly 112 and the seat section 104 are each pivotably coupled to the rear support assembly 108. More specifically, the seat section 104 is arranged so as to pivot about a rear seat axis RSA which extends through the rear uprights 114A, 114B (compare FIGS. 5-6A; pivoting about rear seat axis RSA not shown in detail), and the intermediate arms 118 of the intermediate support assembly 112 are arranged so as to pivot about a rear arm axis RAA which is spaced from the rear seat axis RSA and also extends through the rear uprights 114A, 114B (compare FIGS. 5-6A; pivoting about rear arm axis RAA not shown in detail). Furthermore, the intermediate support assembly 112 and the seat section 104 are also each pivotably coupled to the front support assembly 110. Here, the seat section 104 pivots about a front seat axis FSA which extends through the front struts 116 (compare FIGS. 5-6A; pivoting about front seat axis FSA not shown in detail), and the intermediate arms 118 pivot about a front arm axis FAA which is spaced from the front seat axis FSA and extends through the front struts 116 (compare FIGS. 5-6A; pivoting about front arm axis FAA not shown in detail). The intermediate support assembly 112 is disposed generally vertically below the seat section 104 such that the rear support assembly 108, the front support assembly 110, the intermediate support assembly 112, and the seat section 104 generally define a four-bar linkage which helps facilitate movement between the stowed configuration WC (see FIG. 5) and the chair configuration CC (see FIG. 6A). While the seat section 104 is generally configured to remain stationary relative to the support structure 102 when operating in the chair configuration CC or in the stair configuration CC according to the illustrated versions, it is contemplated that the seat section 104 could comprise multiple components which cooperate to facilitate “sliding” movement relative to the seat section 104 under certain operating conditions, such as to position the patient's center of gravity advantageously for transport. Other configurations are contemplated.

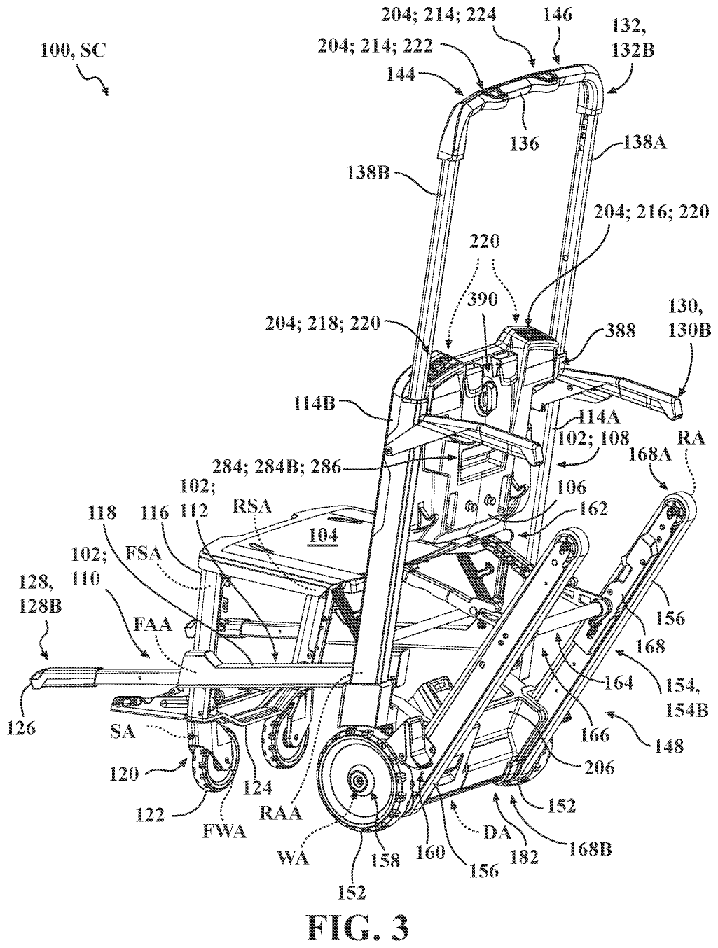

Referring now to FIGS. 1-3, the front support assembly 110 includes a pair of caster assemblies 120 which each comprise a front wheel 122 arranged to rotate about a respective front wheel axis FWA and to pivot about a respective swivel axis SA (compare FIGS. 5-6A; pivoting about swivel axis SA not shown in detail). The caster assemblies 120 are generally arranged on opposing lateral sides of the front support assembly 110 and are operatively attached to the front struts 116. A stiffening brace 124 (see FIG. 3) extends laterally between the front struts 116 to, among other things, afford rigidity to the support structure 102. Here, a foot rest 126 is pivotably coupled to each of the front struts 116 adjacent to the caster assemblies 120 (pivoting not shown in detail) to provide support to the patient's feet during transport. For each of the pivotable connections disclosed herein, it will be appreciated that one or more fasteners, bushings, bearings, washers, spacers, and the like may be provided to facilitate smooth pivoting motion between various components.

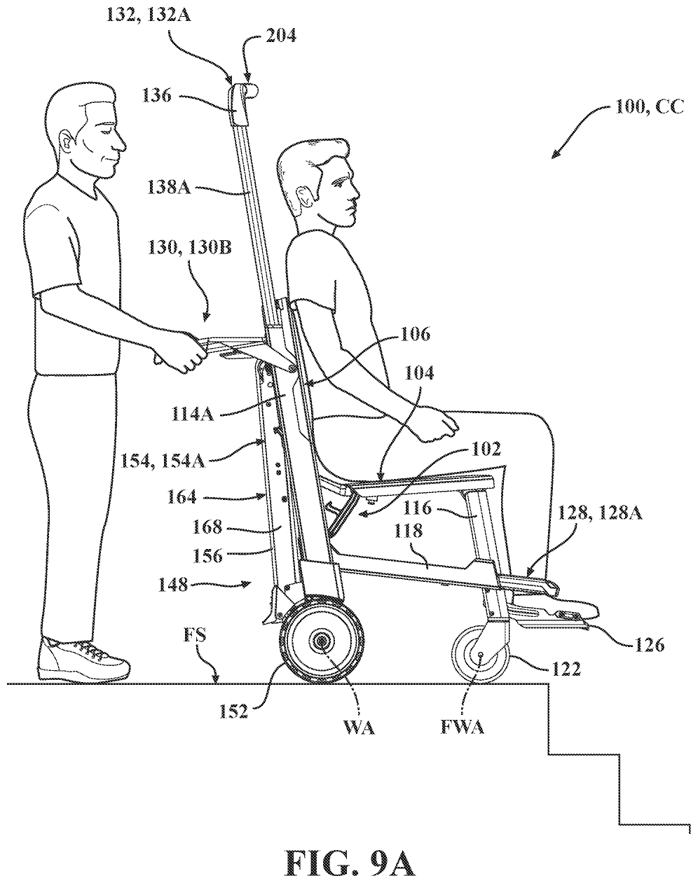

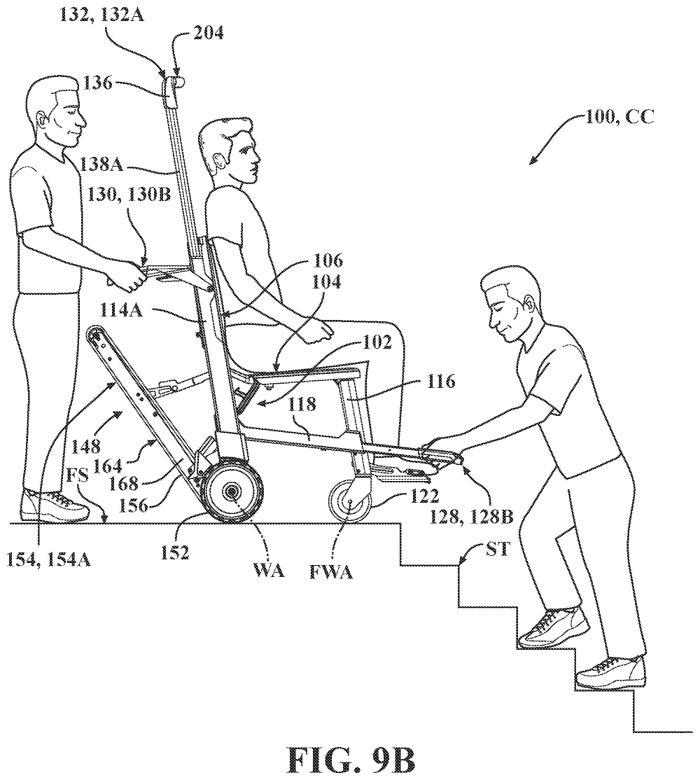

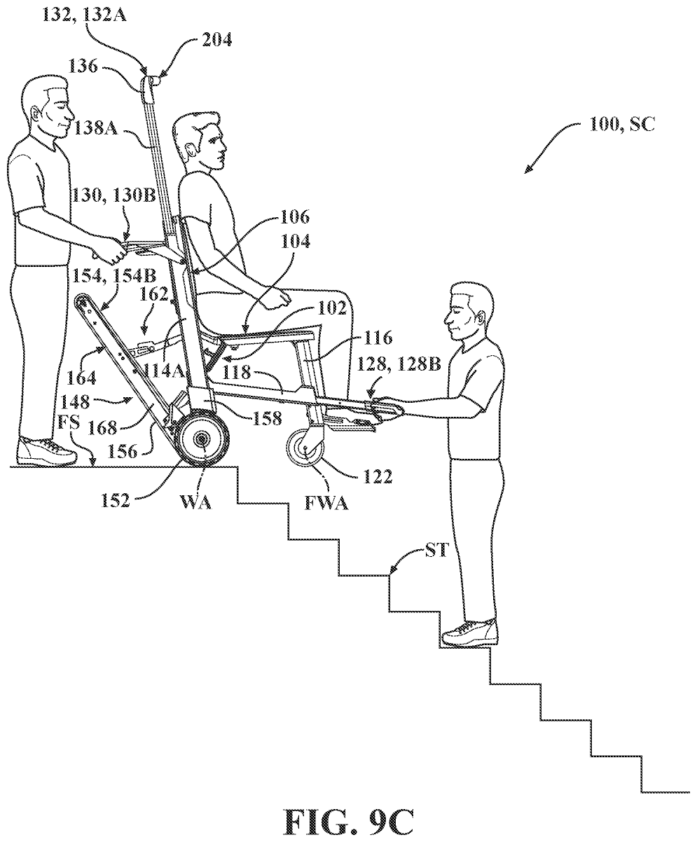

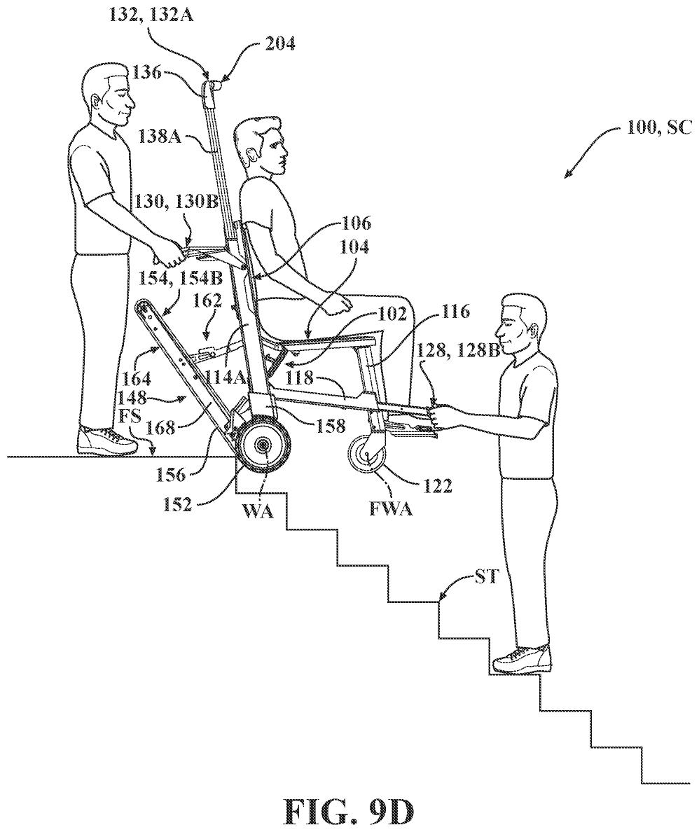

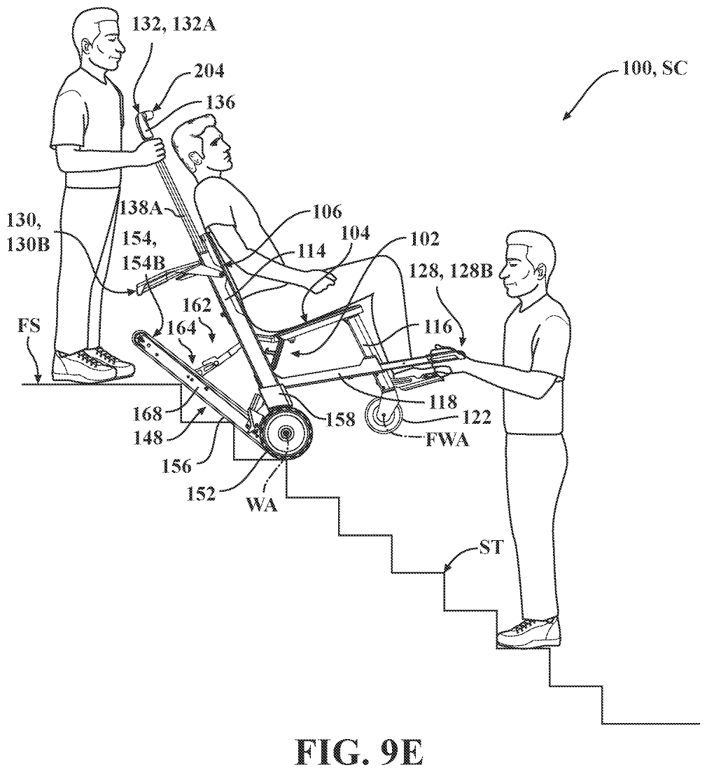

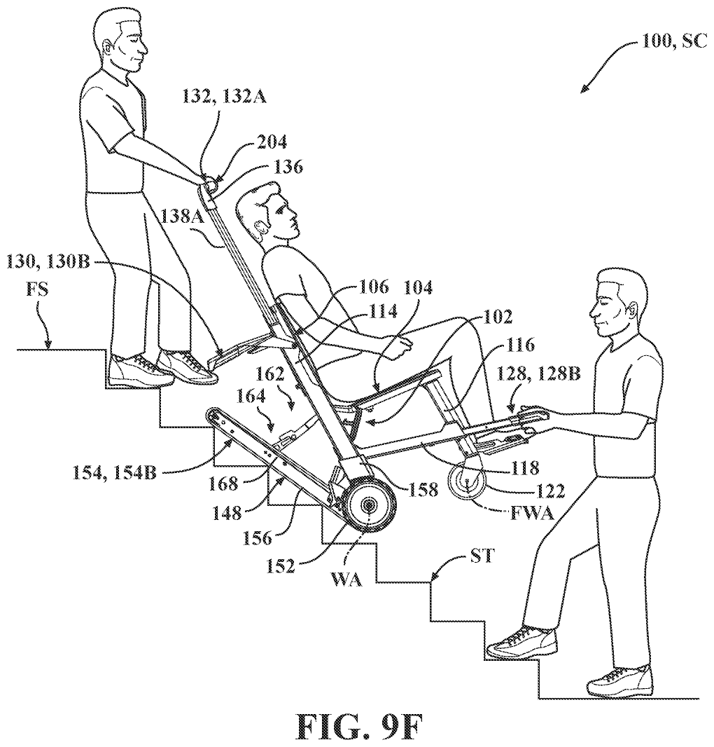

The representative versions of the patient transport apparatus 100 illustrated throughout the drawings comprise different handles arranged for engagement by caregivers during patient transport. More specifically, the patient transport apparatus 100 comprises front handle assemblies 128, pivoting handle assemblies 130, and an upper handle assembly 132 (hereinafter referred to as “handle assembly 132”), each of which will be described in greater detail below. The front handle assemblies 128 are supported within the respective intermediate arms 118 for movement between a collapsed position 128A (see FIG. 9A) and an extended position 128B (see FIG. 9B). To this end, the front handle assemblies 128 may be slidably supported by bushings, bearings, and the like (not shown) coupled to the intermediate arms 118, and may be lockable in and/or between the collapsed position 128A and the extended position 128B via respective front handle locks 134 (see FIG. 1).

Here, a caregiver may engage the front handle locks 134 (not shown in detail) to facilitate moving the front handle assemblies 128 between the collapsed position 128A and the extended position 128B. The front handle assemblies 128 are generally arranged so as to be engaged by a caregiver during patient transport up or down stairs ST when in the extended position 128B. It will be appreciated that the front handle assemblies 128 could be of various types, styles, and/or configurations suitable to be engaged by caregivers to support the patient transport apparatus 100 for movement. While the illustrated front handle assemblies 128 are arranged for telescoping movement, other configurations are contemplated. By way of non-limiting example, the front handle assemblies 128 could be pivotably coupled to the support structure 102 or other parts of the patient transport apparatus 100. In some versions, the front handle assemblies 128 could be configured similar to as is disclosed in U.S. Pat. No. 6,648,343, the disclosure of which is hereby incorporated by reference in its entirety.

The pivoting handle assemblies 130 are coupled to the respective rear uprights 114A, 114B of the rear support assembly 108, and are movable relative to the rear uprights 114A, 114B between a stowed position 130A and an engagement position 130B. Like the front handle assemblies 128, the pivoting handle assemblies 130 are generally arranged for engagement by a caregiver during patient transport, and may advantageously be utilized in the engagement position 130B when the patient transport apparatus 100 operates in the chair configuration CC to transport the patient along floor surfaces FS. In some versions, the pivoting handle assemblies 130 could be configured similar to as is disclosed in U.S. Pat. No. 6,648,343, previously incorporated by reference. Other configurations are contemplated.

As noted above, the patient transport apparatus 100 is configured for use in transporting the patient across floor surfaces FS, such as when operating in the stair configuration SC, and for transporting the patient along stairs ST when operating in the stair configuration SC. To these ends, the illustrated patient transport apparatus 100 includes a carrier assembly 148 arranged for movement relative to the support structure 102 between the chair configuration CC and the stair configuration ST. The carrier assembly 148 generally comprises at least one shaft 150 defining a wheel axis WA, one or more rear wheels 152 supported for rotation about the wheel axis WA, at least one track assembly 154 having a belt 156 for engaging stairs ST, and one or more hubs 158 supporting the shaft 150 and the track assembly 154 and the shaft 150 for concurrent pivoting movement about a hub axis HA. Here, movement of the carrier assembly 148 from the chair configuration CC (see FIG. 1) to the stair configuration SC (see FIGS. 2 and 6B) simultaneously deploys the track assembly 154 for engaging stairs ST with the belt 156 and moves the wheel axis WA longitudinally closer to the front support assembly 110 so as to position the rear wheels 152 further underneath the seat section 104 and closer to the front wheels 122.

As is described in greater detail below in connection with FIGS. 9A-9F, the movement of the rear wheels 152 relative to the front wheels 122 when transitioning from the chair configuration CC to the stair configuration SC that is afforded by the patient transport apparatus 100 of the present disclosure affords significant improvements in patient comfort and caregiver usability, in that the rear wheels 152 are arranged to promote stable transport across floor surfaces FS in the chair configuration CC but are arranged to promote easy transitioning from floor surfaces to stairs ST as the patient transport apparatus 100 is “tilted” backwards about the rear wheels 152 (compare FIGS. 9D-9F). Put differently, positioning the rear wheels 152 relative to the front wheels 122 consistent with the present disclosure makes “tilting” the patient transport apparatus 100 significantly less burdensome for the caregivers and, at the same time, much more comfortable for the patient due to the arrangement of the patient's center of gravity relative to the portion of the rear wheels 152 contacting the floor surface FS as the patient transport apparatus 100 is “tilted” backwards to transition into engagement with the stairs ST.

In the representative versions illustrated herein, the carrier assembly 148 comprises hubs 158 that are pivotably coupled to the respective rear uprights 114A, 114B for concurrent movement about the hub axis HA. Here, one or more bearings, bushings, shafts, fasteners, and the like (not shown in detail) may be provided to facilitate pivoting motion of the hubs 158 relative to the rear uprights 114A, 114B. Similarly, bearings and/or bushings (not shown) may be provided to facilitate smooth rotation of the rear wheels 152 about the wheel axis WA. Here, the shafts 150 may be fixed to the hubs 158 such that the rear wheels 152 rotate about the shafts 150 (e.g., about bearings supported in the rear wheels 152), or the shafts 150 could be supported for rotation relative to the hubs 158. Each of the rear wheels 152 is also provided with a wheel lock 160 coupled to its respective hub 158 to facilitate inhibiting rotation about the wheel axis WA. The wheel locks 160 are generally pivotable relative to the hubs 158, and may be configured in a number of different ways without departing from the scope of the present disclosure. While the representative version of the patient transport apparatus 100 illustrated herein employs hubs 158 with “mirrored” profiles that are coupled to the respective rear uprights 114A, 114B and support discrete shafts 150 and wheel locks 160, it will be appreciated that a single hub 158 and/or a single shaft 150 could be employed. Other configurations are contemplated.

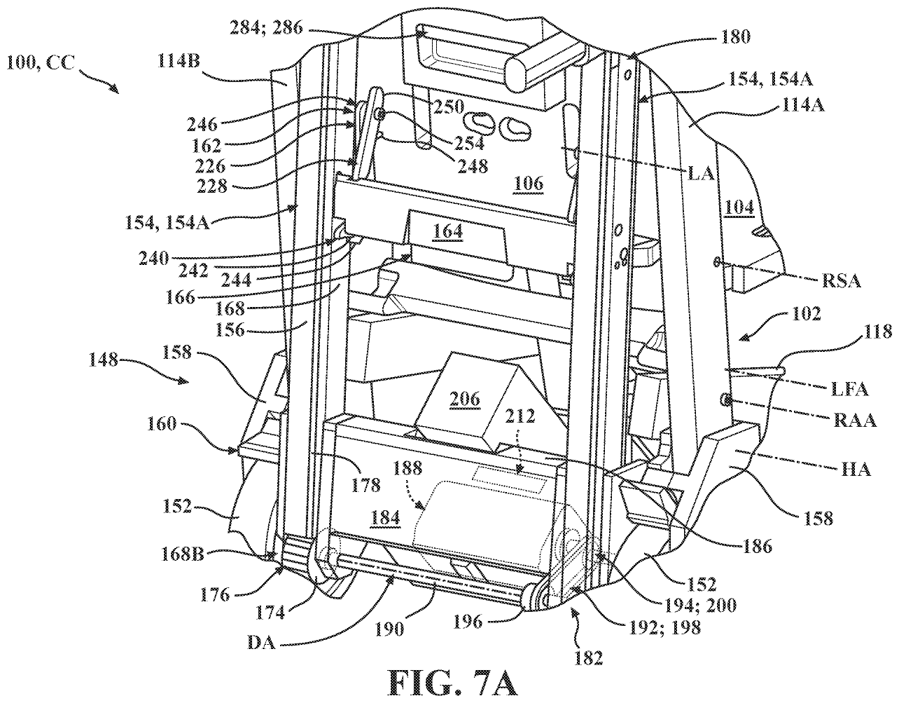

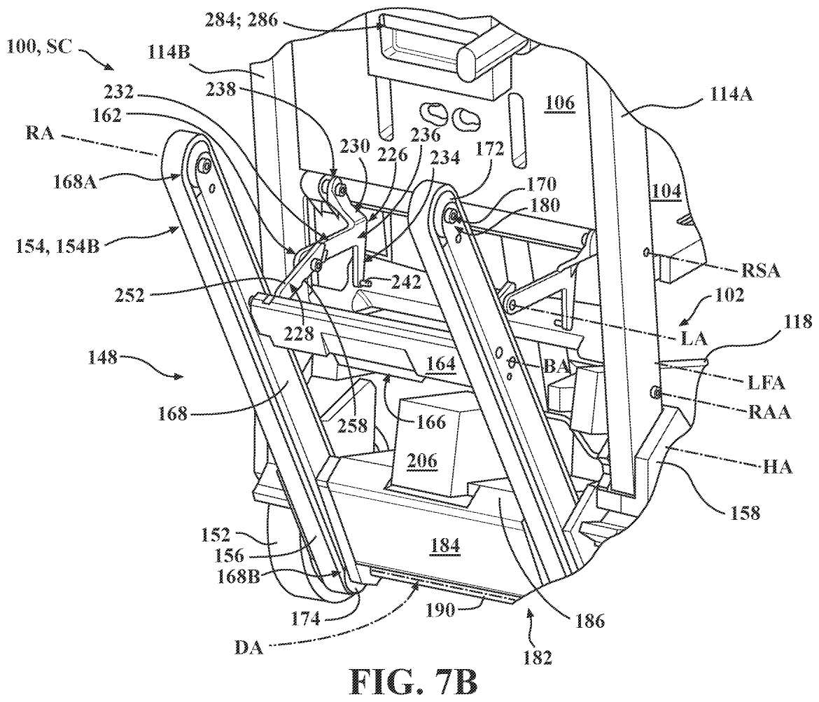

Referring now to FIGS. 7A-7B, as noted above, the track assemblies 154 move concurrently with the hubs 158 between the chair configuration CC and the stair configuration SC. Here, the track assemblies 154 are arranged in a retracted position 154A when the carrier assembly 148 is disposed in the chair configuration CC, and are disposed in a deployed position 154B when the carrier assembly 148 is disposed in the stair configuration SC. As is described in greater detail below, the illustrated patient transport apparatus 100 comprises a deployment linkage 162 and a deployment lock mechanism 164 with a deployment lock release 166 arranged for engagement by the caregiver to facilitate changing between the retracted position 154A and the deployed position 154B (and, thus, between the chair configuration CC and the stair configuration SC).

In the illustrated version, the patient transport apparatus 100 comprises laterally-spaced track assemblies 154 each having a single belt 156 arranged to contact stairs ST. However, it will be appreciated that other configurations are contemplated, and a single track assembly 154 and/or track assemblies with multiple belts 156 could be employed. The track assemblies 154 each generally comprise a rail 168 extending between a first rail end 168A and a second rail end 168B. The second rail end 168B is operatively attached to the hub 158, such as with one or more fasteners (not shown in detail). An axle 170 defining a roller axis RA is disposed adjacent to the first rail end 168A of each rail 168, and a roller 172 is supported for rotation about the roller axis RA. For each of the track assemblies 154, the belt 156 is disposed in engagement with the roller 172 and is arranged for movement relative to the rail 168 in response to rotation of the roller 172 about the roller axis RA.

Adjacent to the second rail end 168B of each rail 168, a drive pulley 174 is supported for rotation about a drive axis DA and is likewise disposed in engagement with the belt 156 (see FIGS. 7A-7B; rotation about drive axis DA not shown in detail). Here, the drive pulley 174 comprises outer teeth 176 which are disposed in engagement with inner teeth 178 formed on the belt 156 (see FIG. 7A; inner teeth 178 not depicted in detail). The track assemblies 154 each also comprise a belt tensioner, generally indicated at 180, configured to adjust tension in the belt 156 between the roller 172 and the drive pulley 174. Suitable belt tensioners are described in U.S. patent application Ser. No. 17/131,935, the disclosure of which is hereby incorporated by reference in its entirety. The track assemblies are described in further detail below.

In the representative version illustrated herein, the patient transport apparatus 100 comprises a drive system, generally indicated at 182, configured to facilitate driving the belts 156 of the track assemblies 154 relative to the rails 168 to facilitate movement of the patient transport apparatus 100 up and down stairs ST. To this end, and as is depicted in FIG. 7A, the drive system 182 comprises a drive frame 184 and a cover 186 which are operatively attached to the hubs 158 of the carrier assembly 148 for concurrent movement with the track assemblies 154 between the retracted position 154A and the deployed position 154B. A motor 188 (depicted in phantom in FIG. 7A) is coupled to the drive frame 184 and is concealed by the cover 186. The motor 188 is configured to selectively generate rotational torque used to drive the belts 156 via the drive pulleys 174, as described in greater detail below. To this end, a drive axle 190 is coupled to each of the drive pulleys 174 and extends along the drive axis DA laterally between the track assemblies 154. The drive axle 190 is rotatably supported by the drive frame 184, such as by one or more bearings, bushings, and the like (not shown in detail). A geartrain 192 is disposed in rotational communication between the motor 188 and the drive axle 190. To this end, in the version depicted in FIG. 7A, the geartrain 192 comprises a first sprocket 194, a second sprocket 196, and an endless chain 198. Here, the motor 188 comprises an output shaft 200 to which the first sprocket 194 is coupled, and the second sprocket 196 is coupled to the drive axle 190. The endless chain 198, in turn, is supported about the first sprocket 194 and the second sprocket 196 such that the drive axle 190 and the output shaft 200 rotate concurrently. The geartrain 192 may be configured so as to adjust the rotational speed and/or torque of the drive axle 190 relative to the output shaft 200 of the motor, such as by employing differently-configured first and second sprockets 194, 196 (e.g., different diameters, different numbers of teeth, and the like).

While the representative version of the drive system 182 illustrated herein utilizes a single motor 188 to drive the belts 156 of the track assemblies 154 concurrently using a chain-based geartrain 192, it will be appreciated that other configurations are contemplated. By way of non-limiting example, multiple motors 188 could be employed, such as to facilitate driving the belts 156 of the track assemblies 154 independently. Furthermore, different types of geartrains 192 are contemplated by the present disclosure, including without limitation the geartrains 192 which comprise various arrangements of gears, planetary gearsets, and the like.

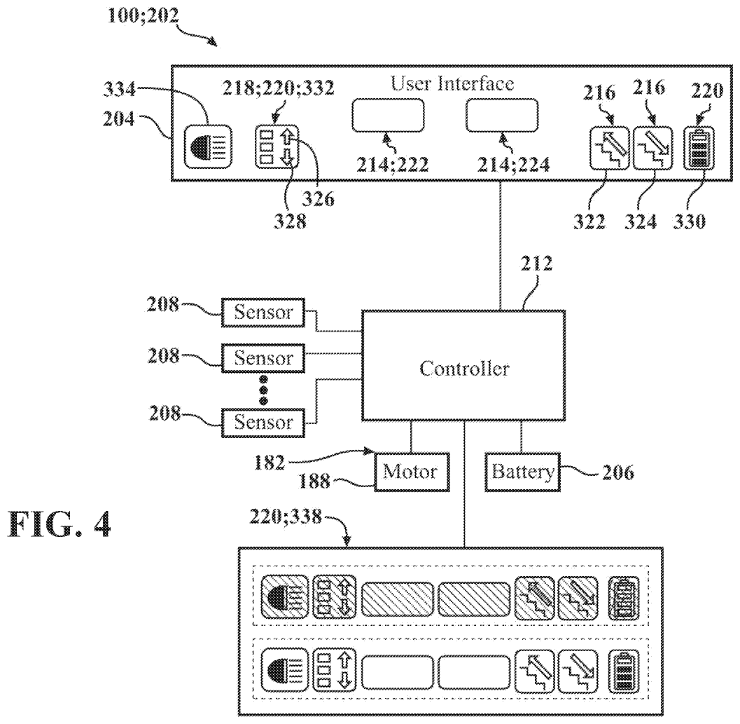

The patient transport apparatus 100 comprises a control system 202 to, among other things, facilitate control of the track assemblies 154. To this end, and as is depicted schematically in FIG. 4, the representative version of the control system 202 generally comprises a user interface 204, a battery 206, one or more sensors 208, and one or more back light modules 210 which are disposed in electrical communication with a controller 212. As will be appreciated from the subsequent description below, the controller 212 may be of a number of different types, styles, and/or configurations, and may employ one or more microprocessors for processing instructions or an algorithm stored in memory to control operation of the motor 188, the light modules 210, and the like. Additionally or alternatively, the controller 212 may comprise one or more sub-controllers, microcontrollers, field programmable gate arrays, systems on a chip, discrete circuitry, and/or other suitable hardware, software, and/or firmware that is capable of carrying out the functions described herein.

The controller 212 is coupled to various electrical components of the patient transport apparatus 100 (e.g., the motor 188) in a manner that allows the controller 212 to control or otherwise interact with those electrical components the (e.g., via wired and/or wireless electrical communication). In some versions, the controller 212 may generate and transmit control signals to the one or more powered devices, or components thereof, to drive or otherwise facilitate operating those powered devices, or to cause the one or more powered devices to perform one or more of their respective functions.

The controller 212 may utilize various types of sensors 208 of the control system 202, including without limitation force sensors (e.g., load cells), timers, switches, optical sensors, electromagnetic sensors, motion sensors, accelerometers, potentiometers, infrared sensors, ultrasonic sensors, mechanical limit switches, membrane switches, encoders, and/or cameras. One or more sensors 208 may be used to detect mechanical, electrical, and/or electromagnetic coupling between components of the patient transport apparatus 100. Other types of sensors 208 are also contemplated. Some of the sensors 208 may monitor thresholds movement relative to discrete reference points. The sensors 208 can be located anywhere on the patient transport apparatus 100, or remote from the patient transport apparatus 100. Other configurations are contemplated.

The battery 206 provides power to the controller 212, the motor 188, the light modules 210, and other components of the patient transport apparatus 100 during use, and is removably attachable to the cover 186 of the drive system 182 in the illustrated version (see FIG. 7A; attachment not shown in detail). The user interface 204 is generally configured to facilitate controlling the drive direction and drive speed of the motor 188 to move the belts 156 of the track assembly 154 and, thus, allow the patient transport apparatus 100 to ascend or descend stairs ST. Here, the user interface 204 may comprise one or more activation input controls 214 to facilitate driving the motor 188 in response to engagement by the caregiver, one or more direction input controls 216 to facilitate changing the drive direction of the motor 188 in response to engagement by the caregiver, and/or one or more speed input controls 218 to facilitate operating the motor 188 at different predetermined speeds selectable by the caregiver. The user interface 204 may also comprise various types of indicators 220 to display information to the caregiver. It will be appreciated that the various components of the control system 202 introduced above could be configured and/or arranged in a number of different ways, and could communicate with each other via one or more types of electrical communication facilitated by wired and/or wireless connections. Other configurations are contemplated.

In the illustrated versions, the patient transport apparatus 100 is configured to limit movement of the belts 156 relative to the rails 168 during transport along stairs ST in an absence of engagement with the activation input controls 214 by the caregiver. Put differently, one or more of the controller 212, the motor 188, the geartrain 192, and/or the track assemblies 154 may be configured to “brake” or otherwise prevent movement of the belts 156 unless the activation input controls 214 are engaged. To this end, the motor 188 may be controlled via the controller 212 to prevent rotation (e.g., driving with a 0% pulse-width modulation PWM signal) in some versions. However, other configurations are contemplated, and the patient transport apparatus 100 could be configured to prevent movement of the belts 156 in other ways. By way of non-limiting example, a mechanical brake system (not shown) could be employed in some versions.

Referring now to FIG. 7A, the patient transport apparatus 100 employs the deployment lock mechanism 164 to releasably secure the track assembly 154 in the retracted position 154A and in the deployed position 154B. The deployment lock release 166 is arranged for engagement by the caregiver to move between the retracted position 154A and the deployed position 154B. The deployment lock mechanism 164 is coupled to the track assemblies 154 for concurrent movement, and the deployment linkage 162 is coupled between the deployment lock mechanism 164 and the support structure 102. The illustrated deployment linkage 162 generally comprises connecting links 226 which are pivotably coupled to the support structure 102, and brace links 228 which are coupled to the deployment lock mechanism 164 and are respectively pivotably coupled to the connecting links 226.

The connecting links 226 each comprise or otherwise define a forward pivot region 230, a connecting pivot region 232, a trunnion region 234, and an interface region 236. The forward pivot regions 230 extend from the interface regions 236 to forward pivot mounts 238 which are pivotably coupled to the rear uprights 114A, 114B about the rear seat axis RSA, such as by one or more fasteners, bushings, bearings, and the like (not shown in detail). Here, because the rear uprights 114A, 114B are spaced laterally away from each other at a distance large enough to allow the track assemblies 154 to “nest” therebetween in the retracted position 154A (see FIG. 7A), the forward pivot regions 230 of the connecting links 226 extend at an angle away from the rear uprights 114A, 114B at least partially laterally towards the track assemblies 154.

The trunnion regions 234 extend generally vertically downwardly from the interface regions 236 to trunnion mount ends 240, and comprise trunnions 242 which extend generally laterally and are arranged to abut trunnion catches 244 of the deployment lock mechanism 164 to retain the track assemblies 154 in the retracted position 154A (see FIG. 7A). The connecting pivot regions 232 extend longitudinally away from the interface regions 236 to rearward pivot mounts 246 which pivotably couple to the brace links 228 about a link axis LA. The connecting links 226 are each formed as separate components with mirrored profiles in the illustrated versions, but could be realized in other ways, with any suitable number of components.

The brace links 228 each generally extend between an abutment link end 250 and a rearward link mount 252, with a forward link mount 254 arranged therebetween. The forward link mounts 254 are pivotably coupled to the rearward pivot mounts 246 of the connecting links 226 about the link axis LA, such as by one or more fasteners, bushings, bearings, and the like (not shown in detail). The rearward link mounts 252 are each operatively attached to the deployment lock mechanism 164 about a barrel axis BA. The brace links 228 each define a link abutment surface 256 disposed adjacent to the abutment link end 250 which are arranged to abut the link stops 248 of the connecting links 226 in the deployed position 154B (see FIG. 7B). The brace links 228 also define a relief region 258 formed between the forward link mount 254 and the rearward link mount 252. The relief regions 258 are shaped to at least partially accommodate the link stops 248 of the connecting links 226 when the track assemblies 154 are in the retracted position 154A (not shown in detail). The deployment linkage 162, the deployment lock mechanism 164, and the deployment lock release 166 may be similar to as is disclosed by U.S. Patent Application Publication No. 20210196536, the disclosure of which is hereby incorporated by reference in its entirety.

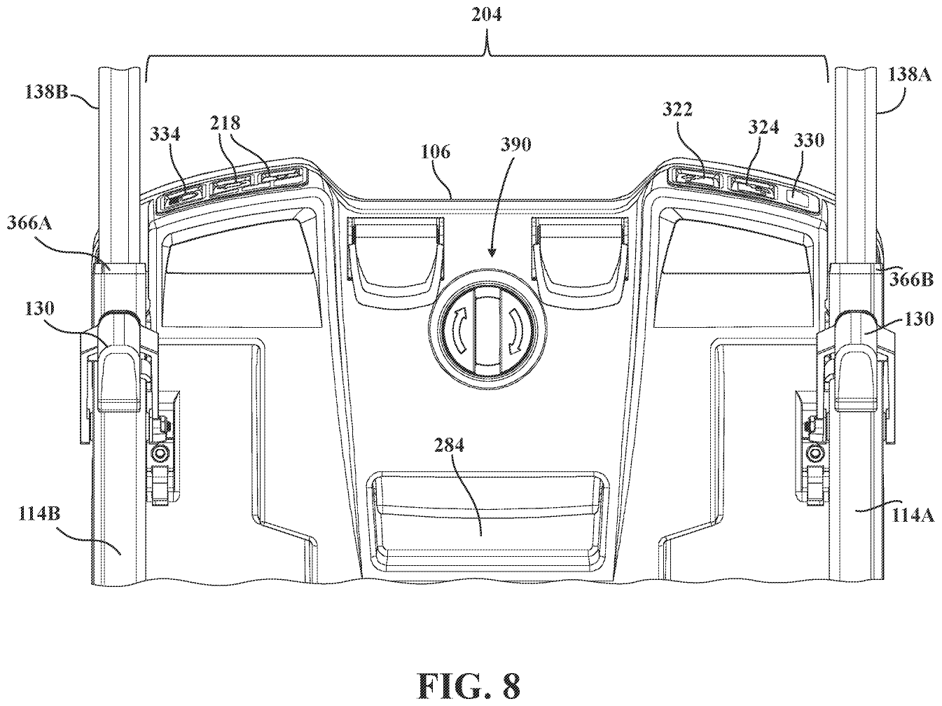

With continued reference to FIGS. 7A and 7B and additional reference to FIG. 8, the patient transport apparatus 100 employs a folding lock mechanism 284 to facilitate changing between the stowed configuration WC (see FIG. 5) and the chair configuration CC (see FIG. 6A). To this end, the folding lock mechanism 284 generally comprises a folding lock release 286 operatively attached to the back section 106 and arranged for engagement by the caregiver to releasably secure the folding lock mechanism 284 between a stow lock configuration to maintain the stowed configuration WC, and a use lock configuration to prevent movement to the stowed configuration WC from the chair configuration CC or from the stair configuration SC. The folding lock mechanism 284 may incorporate features as disclosed in U.S. Pat. No. 6,648,343 previously incorporated by reference and as disclosed in U.S. Patent Application Publication No. 20210196536, previously incorporated by reference.

The drive system 182 may include various components not specifically illustrated or be configured in various ways not discussed in detail but described in U.S. Patent Application Publication No. 20210196536, previously referenced and incorporated by reference. In a version, the motor 188 may be supported on an adjustable platform that is movable relative to the drive frame 184 to adjust slack in the endless chain. This arrangement helps to optimize power density and minimize weight in the drive system 182. It will be appreciated that this arrangement could be utilized with other types of geartrains 192, such as where a belt drive (not shown) would replace the endless chain 198. Other configurations are contemplated.

In some versions, the geartrain 192 may be configured with a direct drive gearbox coupled to one of the rails 168 of the track assembly 154. Here, the drive axle 190 extends through the direct drive gearbox, and the motor 188 may be coupled to the direct drive gearbox. In some versions, the patient transport apparatus 100 may include a “passive brake” that allows the speed of the patient transport apparatus 100 to be controlled when on stairs ST even when the battery 206 is of low charge, dead, or not connected to the drive system 182 (e.g., inadvertently removed).

FIGS. 9A-9F successively depict exemplary steps of transporting a patient supported on the patient transport apparatus 100 down the stairs ST. In FIG. 9A, a first caregiver is shown engaging the pivoting handle assemblies 130 in the engagement position 130B to illustrate approaching stairs ST while the patient transport apparatus 100 is moved along floor surfaces FS in the chair configuration CC. In FIG. 9B, the patient transport apparatus 100 has been moved closer to the stairs with a second caregiver engaging the front handle assemblies 128 after having moved them to the extended position 128B. The deployment lock release 166 was also deployed by the first caregiver to move the patient transport apparatus 100 into the stair configuration SC as shown. As shown in the stair configuration SC, the track assemblies 154 are arranged in the deployed position 154B. Here, the rear wheels 152 are positioned significantly closer to the front wheels 122 compared to operation in the chair configuration CC, and are also arranged further under the seat section 104. It will be appreciated that transitioning the patient transport apparatus 100 from the chair configuration CC to the stair configuration SC has resulted in minimal patient movement relative to the support structure 102 as the carrier assembly 148 pivots about the hub axis HA and moves the rear wheels 152 closer to the front wheels 122 in response to movement of the track assemblies 154 to the deployed position 154B.

Furthermore, while the arrangement of the patient's center of gravity has not changed significantly relative to the support structure 102, the longitudinal distance which extends between the patient's center of gravity and the location at which the rear wheels 152 contact the floor surface FS has shortened considerably. Because of this, the process of “tilting” the patient transport apparatus 100 (e.g., about the rear wheels 152) to transition toward contact between the track assemblies 154 and the stairs ST, as depicted in FIG. 9C, is significantly more comfortable for the patient than would otherwise be the case if the patient transport apparatus 100 were “tilted” about the rear wheels 152 from the chair configuration CC (e.g., with the rear wheels 152 positioned further away from the front wheels 122). Put differently, the arrangement depicted in FIG. 9C is such that the patient is much less likely to feel uncomfortable, unstable, or as if they are “falling backwards” during the “tilting” process. Here too, the caregivers are afforded with similar advantages in handling the patient transport apparatus 100, as the arrangement of the rear wheel 152 described above also makes the “tilting” process easier to control and execute. In FIG. 9D, the caregivers are shown continuing to support the patient transport apparatus 100 in the stair configuration SC as the belts 156 of the track assemblies 154 are brought into contact with the edge of the top stair ST.

In FIGS. 9E and 9F, the caregivers are shown continuing to support the patient transport apparatus 100 in the stair configuration SC as the belts 156 of the track assemblies 154 contact multiple stairs ST during descent

The patient transport apparatus 100 is configured to operate in a variety of states and modes in certain versions, including for example in or between one or more inactive states SI and/or one or more active states SA. During the inactive state SI, power consumption of the patient transport apparatus 100 is limited as the motor is not controlling movement of the belt during this state, and during the active state SA the controller 212 may be utilized to control movement of the belt 156 with the motor 188 of the patient transport apparatus 100.

It will be appreciated that the controller 212 may be configured to operate in a variety of inactive states SI and active states SA. The controller 212 may be configured to operate in (or between) a sleep mode MS of the inactive state SI and an active mode MS of the inactive state SI. The controller 212 may also operate in a variety of inactive states, for example, a low charge mode MLC of the inactive state SI, and/or a battery disconnect mode MBD of the inactive state SI which are discussed in detail in U.S. Patent Application Publication No. 20210196539A1, the disclosure of which is hereby incorporated by reference in its entirety.

During the sleep mode MS of the inactive state SI, power consumption of the patient transport apparatus 100 is limited. In some versions, power consumption of the patient transport apparatus 100 may be limited by only allowing the controller 212 to provide power from the battery 206 to certain components of the patient transport apparatus 100. For example, during the sleep mode MS, the controller 212 may be unable to generate and transmit control signals to some of the one or more powered devices, or components thereof, to drive the patient transport apparatus 100. Here, however, the controller 212 may be configured to provide power to the user interface 204. In the sleep mode MS, the user interface 204 may be prevented from emitting light, but may be configured to receive input generate by user engagement of any portion of the user interface 204. Additionally, in some instances of the sleep mode MS, one or more of the controller 212, the motor 188, the geartrain 192, and/or the track assemblies 154 may also be configured to “brake” or otherwise prevent movement of the belts 156.

During active mode MA of the inactive state, the controller 212 may not limit power consumption of any component of the patient transport apparatus 100. For example, the user interface 204 may emit light for a predetermined period of time in response to user engagement of one of the input controls. Various other components of the patient transport apparatus 100 may be provided power upon demand without limitation during the active mode MA of the inactive state SI.

The controller 212 may be configured to operate in a drive mode MD during the active state SA to control a direction of movement of the belt 156. In some versions, the controller 212 may be configured to additionally operate in additional modes to the drive mode during the active state SA such as a hold mode MH of the active state SA for limiting movement of the belt 156 to facilitate a controlled descent of the patient transport apparatus 100 along stairs ST. The hold mode is disclosed by the discussed in detail in U.S. Patent Application Publication No. 20210196539A1, previously incorporated by reference.

In some versions, the user interface 204 may comprise one or more light modules 210 realized as backlight modules arranged to illuminate various input controls and/or indicators under certain operating conditions. In some versions, the user interface 204 may comprise one or more light modules 210 configured to, among other things, provide status information to the caregiver.

In the representative version illustrated herein, the controller 212 may be operable in sleep mode in which power consumption is limited, and the active mode SA in which power consumption is not limited such as when the controller 212 controls movement of the belt 156 with the motor 188 of the patient transport apparatus 100. As previously described, the controller 212 may be configured to operate in a variety of other modes/states not explicitly discussed herewith but discussed in greater detail in U.S. Patent Application Publication No. 20210196539A1, previously incorporated by reference.

The plurality of drive speeds DS1, DS2, DS3 may correspond to predetermined speed settings (a specific RPM setting) stored in memory of the controller 212. The plurality of drive speeds DS1, DS2, DS3 may include a first drive speed DS1, a second drive speed DS2, and a third drive speed DS3. The first drive speed DS1 corresponds to the lowest of the plurality of drive speeds DS1, DS2, DS3. The third drive speed DS3 corresponds to the highest drive speed of the plurality of drive speeds DS1, DS2, DS3. The second drive speed DS2 corresponds to a speed in between the first drive speed DS1 and the third drive speed DS3. It will be appreciated that the forgoing are non-limiting, illustrative examples of three discreet drive speeds, and other configurations are contemplated, including without limitation additional and/or fewer drive speeds, drive speeds defined in other ways, and the like.

As noted above, the one or more speed input controls 218 may include a first speed input control and a second speed input control. The controller 212 may be configured to increase the selected speed to the next higher drive speed setting in response to the user engagement of the first speed input control. For example, in response to receiving user input generated by user engagement of a first speed input control when the current selected drive speed is the first drive speed DS1, the controller 212 may set the current speed to the second drive speed DS2. The controller 212 may be configured to decrease the selected drive speed to the next lower drive speed setting in response to user engagement of a second speed input control. For example, when the current selected drive speed is the second drive speed DS2, the controller 212 may set the current speed to the first drive speed DS1 in response to user engagement of the second speed input control.

In some versions, the controller 212 may be configured to initially select the first drive speed DS1 of the plurality of drive speeds DS1, DS2, DS3 in response to user engagement of the direction input controls 216 following the change in operation from the inactive state SI to the active state SA. However, it is contemplated that the controller 212 may be configured alternatively, such as to initially select the second drive speed DS2 or the third drive speed DS3 of the plurality of drive speeds DS1, DS2, DS3.

The controller 212 may be configured to selectively permit operation of the motor 188 in response to receiving user input generated by engagement of one of the activation input controls 214 (e.g., the first activation input control 222 or the second activation input control 224). For example, the controller 212 may be configured to permit operation of the motor 188 in response to user engagement of at least one of the activation input controls 214 following user engagement of the direction input control 216 to drive the belt 156 in a selected drive direction. In another example, the controller 212 may be configured to permit operation of the motor 188 in response to user engagement of the activation input controls 214 within a predetermined period following engagement of the direction input control 216. After the predetermined period following user engagement of the direction input control 216 has elapsed, the controller 212 may prevent operation of the motor 188 even when one of the activation input controls 214 is engaged. The controller 212 may also be configured to limit operation of the motor 188 in response to receiving the user input before receiving the user input generated by user selection of one of the direction input controls 216.

As is best depicted in FIG. 6B, the rear uprights 114A, 114B each generally extend between a lower upright end 115A and an upper upright end 115B, with the hub axis HA arranged adjacent to the lower upright end 115A. The lower upright end 115A is supported for movement within the hub 158, which may comprise a hollow profile or recess defined by multiple hub housing components. In the illustrated version, the hub axis HA is arranged generally vertically between the rear arm axis RAA and the wheel axis WA.

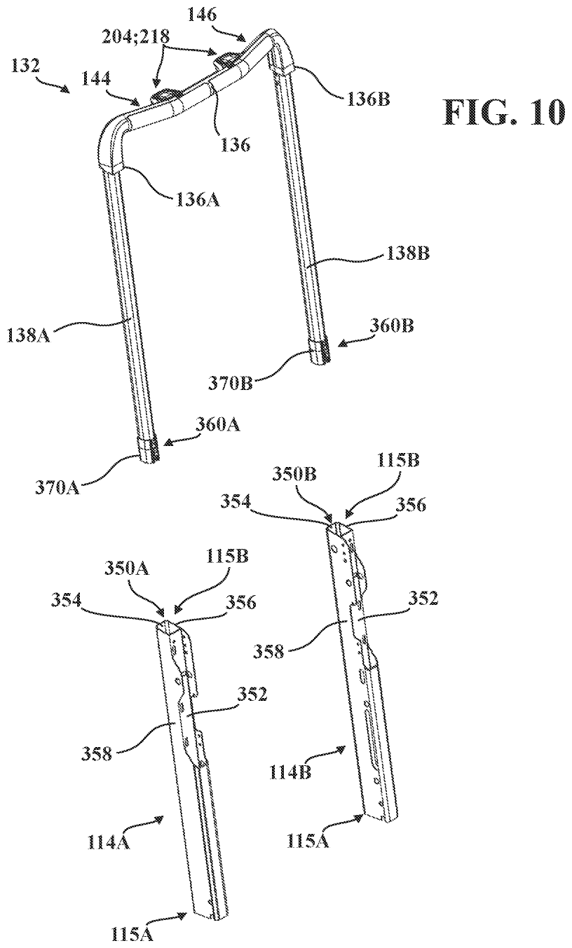

With reference to FIG. 10, the handle assembly 132 includes an upper grip 136. The upper grip 136 is operatively attached to a first extension post 138A. The first extension post 138A is disposed within the first support channel 350A of the first rear upright 114A. Accordingly, the first extension post 138A supports the upper grip 136 for movement of the handle assembly 132 between a collapsed position 132A where the upper grip is disposed adjacent to the user interface (see FIG. 1) and an extended position 132B where the upper grip is spaced from the user interface (see FIG. 2). In some examples, the upper grip 136 may extend between a first upper grip end 136A and a second upper grip end 136B. The first extension post 138A may be operatively attached to the first upper grip end 136A. The handle assembly 132 may further include a second extension post 138B operatively attached to the second upper grip end 136B. Together, the first and second extension posts 138A, 138B may support the upper grip 136 for movement of the handle assembly 132 between the collapsed position 132A and the extended position 132B. The first and/or second extension posts 138A, 138 may define a rounded rectangular profile corresponding to the profile of the first and/or second support channel 350A, 350B.

In the representative version illustrated herein, the upper grip 136 generally comprises a first hand grip region 144 arranged adjacent to the first extension posts 138A, and a second hand grip region 146 arranged adjacent to the second extension post 138B, each of which may be engaged by the caregiver to support the patient transport apparatus 100 for movement, such as during patient transport up or down stairs ST (see FIGS. 9A-9F). The activation input controls 214 may be arranged in various locations about the patient transport apparatus. In the illustrated versions, a first activation input control 222 is disposed adjacent to the first hand grip region 144 of the handle assembly 132, and a second activation input control 224 is disposed adjacent to the second hand grip region 146 (best shown in FIG. 1). In the illustrated version, the user interface 204 is configured such that the caregiver can engage either of the activation input controls 222, 224 with a single hand grasping the upper grip 136 (described below) of the handle assembly 132 during use.

The activation input controls 214 may be arranged between the first and second hand grip regions 144, 146 in order to facilitate user engagement of the activation input controls 214 from either of the first and second hand grip regions 144, 146. As previously discussed, the activation input controls 214 include the first activation input control 222 and the second activation input control 224. The first activation input control 222 may be disposed adjacent the first hand grip region 144 so as to facilitate user engagement of the first activation input control 222 from the first hand grip region 144. The second activation input control 224 may be disposed adjacent to the second hand grip region 146 so as to facilitate user engagement of the second activation input control 224 from the second hand grip region 146. Here, it will be appreciated that the user can engage either of the first and second hang grip regions 144, 146 with one of their hands to support the patient transport apparatus 100 while, at the same, using that same hand to activate one of the first and second activation input controls 222, 224 (e.g., reaching with their thumb). The first activation input control 222 and the second activation input control 224 may be spaced apart by a predetermined distance (e.g., several inches) and may be wired in parallel in some versions (not shown in detail).

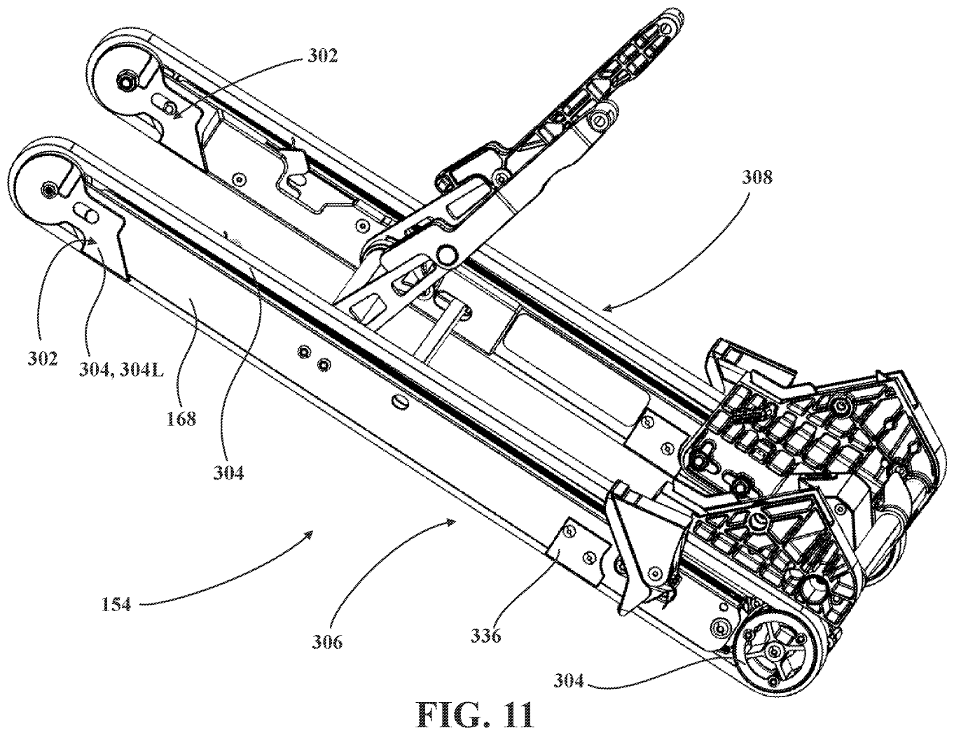

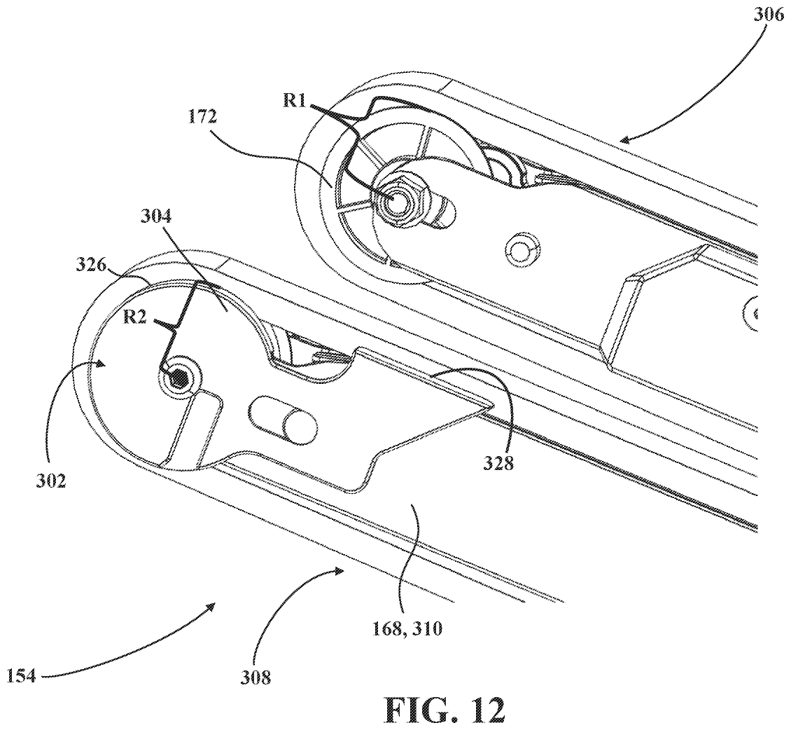

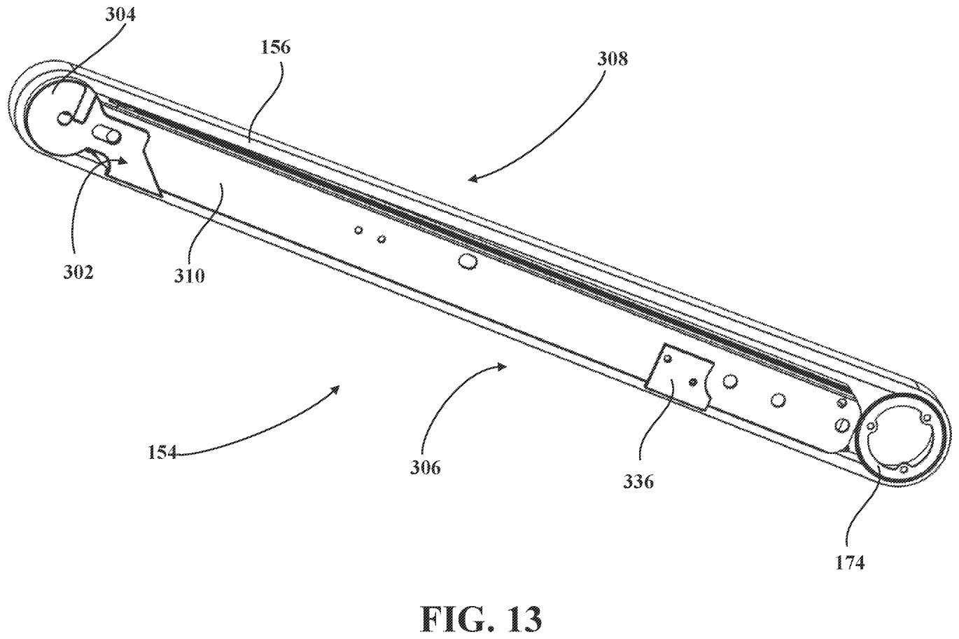

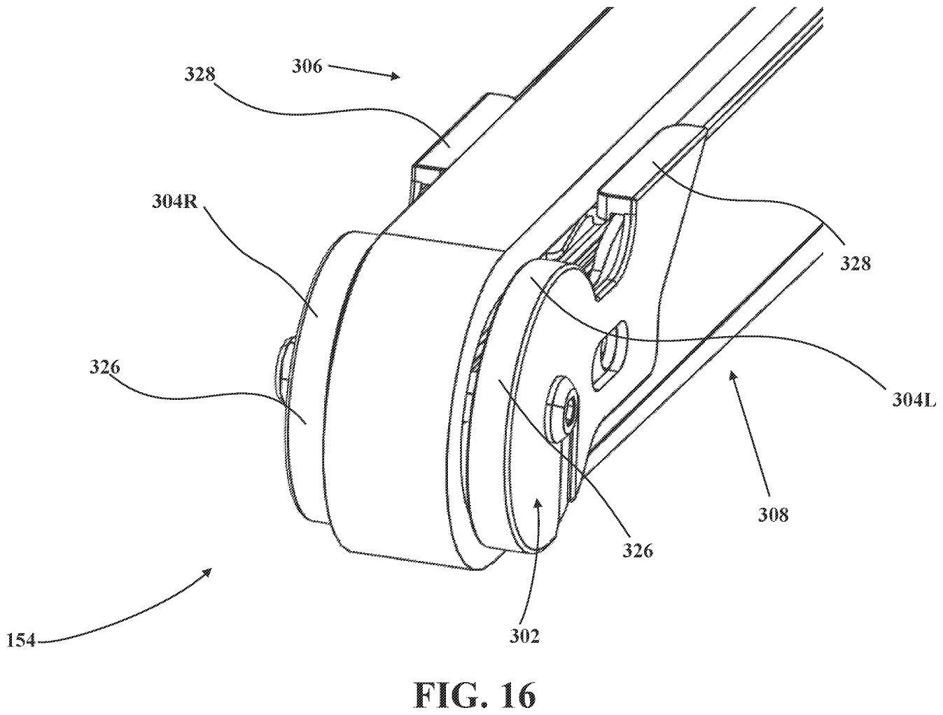

With reference to the collective disclosure of FIGS. 11-17, as described above, the track assembly 154 includes the rail 168 extending between the first rail end 168A and the second rail end 168B. The track assembly 154 also includes the roller 172, the motor 188, and the pully 174. The roller 172 is supported for rotation adjacent to the first rail end 168A, and the motor 188 supports the pulley 174 for rotation adjacent to the second rail end 168B. The track assembly 154 also includes the belt 156 supported in engagement with the roller 172 and the pulley 174 and arranged for movement relative to the rail 168 in response to torque generated by the motor 188. The roller 172 defines a belt contact surface 173 having a width W1 and the belt 156 defines a width W2 that is less than the width W1.

The track assembly 154 further includes a lateral brace 302 operatively attached to the rail 168 and configured to abut at least a portion of the belt 156 to retain the belt 156 in engagement with the roller 172 for limiting lateral movement of the belt 156 relative to the rail 168 occurring in response to force acting on the belt 156 between stairs ST and the roller 172 during operation of the motor 188. In other words, the lateral brace 302 defines a brace 304 configured to maintain and/or restore the proper orientation of the belt 156 relative to the roller 172 when the outside force urges the belt 156 laterally away from the rail 168 and/or roller 172. More specifically, the lateral brace 302 is configured and positioned such that the brace 304 physically contacts the belt 156 if the belt 156 begins to move laterally away from the rail 168 and/or roller 172 due to an outside force, with the contact limiting the lateral movement of the belt 156 and deflecting the belt 156 towards its intended orientation about the rail 168 and engagement with the roller 172. For example, if the caregiver turns the patient transport apparatus 100 when descending stairs ST in a manner that exerts a force against the belt 156 to laterally urge the belt 156 away from the rail 168, the brace 304 is configured to abut the belt 156, thereby limiting the lateral movement of the belt 156 relative to the rail 168, which maintains the engagement between the belt 156 and the roller 172 and maintains the patient transport apparatus 100 in an operational state.

As best shown in FIG. 11, the lateral brace 302 is arranged closer to the first rail end 168A, than the second rail end 168B. Generally, the lateral brace 302 is arranged about the first rail end 168A and adjacent the roller 172. The orientation of the lateral brace 302 is best described relative to the orientation of the rail 168, the roller 172, and the belt 156. The rail 168 includes four main surfaces. The first surface of the rail 168 is a stair-side 306, which is the oriented towards the stairs ST during operation of the track assembly 154. The second surface of the rail 168 is a non-contact side 308, which is opposite the stair-side 306. The belt 156 is arranged over both the stair-side 306 and the non-contact side 308. However, the portion of the belt 156 arranged over the stair-side 306 is positioned to make contact with stairs ST during operation of the track assembly 154. Conversely, the portion of the belt 156 arranged over the non-contact side 308 is positioned to avoid contact with the stairs ST during operation of the track assembly. The third and fourth sides of the rail 168 are first and second sidewalls 310, 312 that extend between the stair-side 306 and the non-contact side 308 of the rail 168.

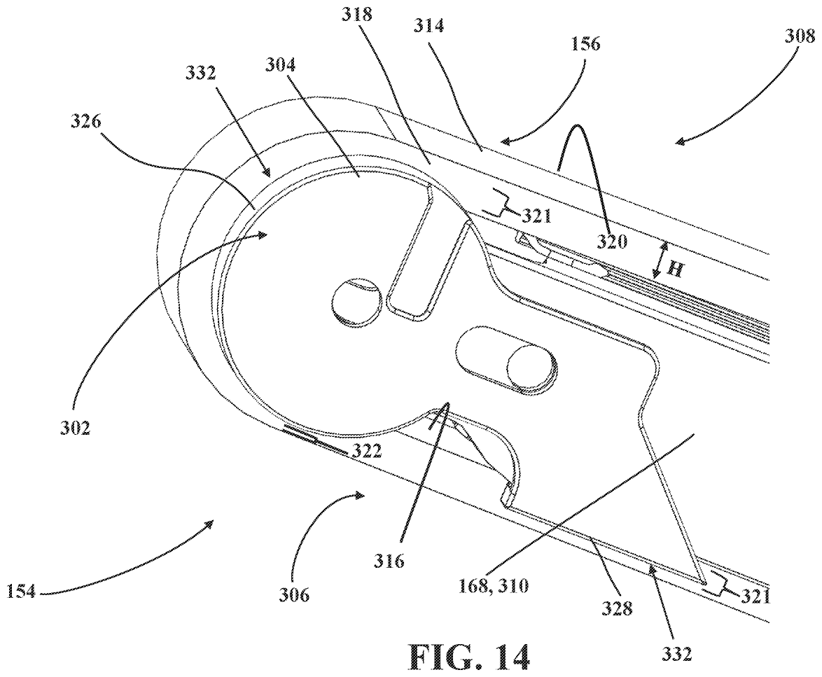

As best shown in FIG. 14, the lateral brace 302 is typically coupled to the first and/or second side wall 310, 312 of the rail 168. For example, the lateral brace 302 may be bolted to the first side wall 310 of the rail 168. The brace 304 defined by the lateral brace 302 is located/extends above the stair-side 306 and/or the non-contact side 308 of the rail 168, and optionally over a portion of the stair-side 306 and/or the non-contact side 308 of the rail 168 towards the belt 156. Because the belt 156 is oriented above the non-contact side 308 and below the stair-side 306 of the rail 168, the brace 304 is arranged laterally adjacent to the belt 156 in both locations. In certain implements, the belt 156 defines an outer belt surface. More specifically, the belt defines a top surface 314, belt bottom surface 316, and two belt sidewalls 318, 320 opposite each other and extending between the belt top surface 314 and belt bottom surface 316. The belt 156 has a height defined as the distance between the belt top surface 314 and belt bottom surface 316. The outer belt surface 311 defines a contact region 321 (not to scale in FIG. 14) along one or both of the belt 156 side walls. The contact region 321 is defined as a zone confined within from about 15% to about 85% of the height (H) of the belt 156 along one or both of its belt sidewalls 318, 320. Due to the orientation of the track assembly 154, when the brace 304 abuts the belt 156, the contact between the brace 304 and belt 156 typically occurs within the contact region 319. The outer belt surface 311 also includes an upper region 322 above the contact region 321, with the upper region 322 avoiding contact with the belt 156 when the belt 156 and the contact region 321 abut each other. Avoiding contact with the upper region 322 is desirable for retaining the engagement between the belt 156 and the roller 172.

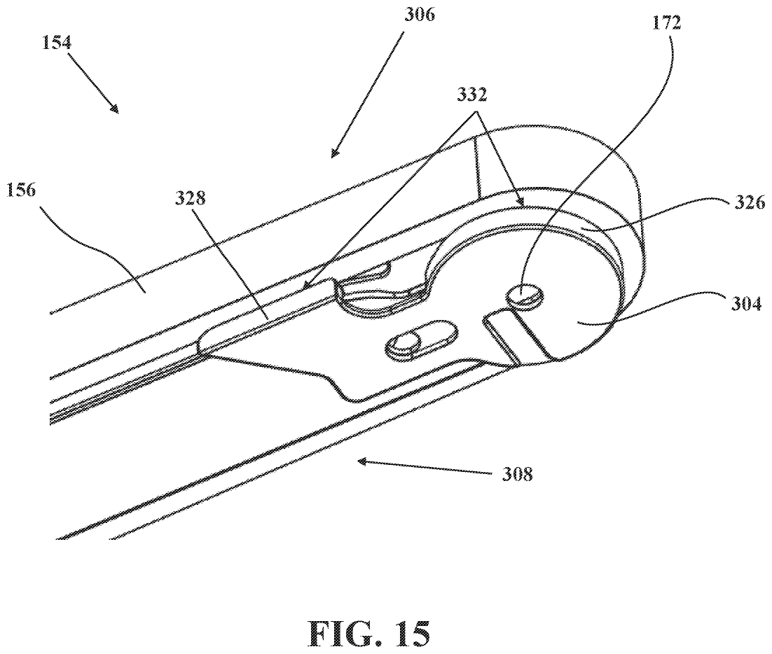

Referring now to FIG. 15, the brace 304 may include a curved region 326 configured to retain the belt 156 about the roller 172, and a linear region 328 configured to retain the belt 156 about the rail 168. The curved region 326 is typically configured to align with the orientation of the belt 156 about the roller 172. For example, when the roller 172 has a circular configuration, the orientation of the belt 156 will include an arcuate segment that is established due to the engagement between the belt 156 and the circular roller 172. The curved region 326 of the roller 172 typically includes a similar arcuate segment to mirror the arcuate segment of the belt 156. Should the belt 156 be urged laterally away from the rail 168, the curved region 326 of the brace 304 is configured to abut the belt 156 about the roller 172 and thereby maintain the engagement between the belt 156 and the roller 172. In certain implements, the curved region 326 and the roller 172 have a common axis (RA, FIG. 7B). Although not required, a bolt may couple the rail 168, the brace 304, and the roller 172 along the common axis (RA). Generally, when the rail 168, the brace 304, and the roller 172 are coupled along the common axis, the roller 172 has a radius R1 and the curved region 326 has a radius R2 that is greater than R1. The radius (R2) of the curved region 326 is greater than that of the radius (R1) of the roller 172, because the curved region 326 is positioned adjacent the belt 156 about the roller 172.

The linear region 328 of the brace 304 is spaced from the roller 172 between the first and second rail ends 168A, 168B. In other words, the linear region 328 of the brace 304 is not disposed about the roller 172. Instead, the curved region 326 of the brace 304 is disposed about the roller 172. The linear region 328 is typically spaced from the curved region 326 by a gap region 334. In particular, the lateral brace 302 may also define the gap region 334, which is a void that separates the curved and linear region 328s. The length of the gap region 334 (i.e., distance between the linear and curved region 326s) is typically greater than the height (H) of the belt 156. Due to the presence of the gap regions 334, the lateral brace 302 avoids contact with the belt 156 between the curved and linear region 326, 328. Although not required, the linear region 328 of the brace 304 is typically located about the belt 156 on the stair-side 306 of the rail 168. In other words, the portion of the brace 304 defining the linear region 328 extends past the stair-side 306 of the rail 168, such that the contact/abutment between the belt 156 and the linear region 328 occurs along the stair-side 306 of the rail 168.

Referring again collectively to FIGS. 11-17, the brace 304 may also be defined to include a leading edge 332 configured to abut the belt 156 along the curved region 326 and the linear region 328. Said differently, the leading edge 332 is the portion of the curved and linear regions 326, 328 that is configured to abut the belt 156. As described above, the leading edge 332 of the linear region 328 is arranged over the stair-side 306 of the rail 168. A length of the leading edge 332 of the linear region 328 is typically greater than the width (W2) of the belt 156. The leading edge 332 of the linear region 328 is configured to maintain a constant distance from the belt 156 along at least 75% of the length of the linear region 328. In contrast, the leading edge 332 of the curved region 326 extends along the non-contact side 308 of the rail 168, the roller 172, and the stair-side 306 of the rail 168. However, the leading edge 332 of the curved region 326 is tapered such that the distance between the belt 156 and the curved region 326 varies. In certain implementations, the distance between the curved region 326 and the contact region 321 of the belt 156 is a minimum distance (MD) on the non-contact side 308 of the rail 168.

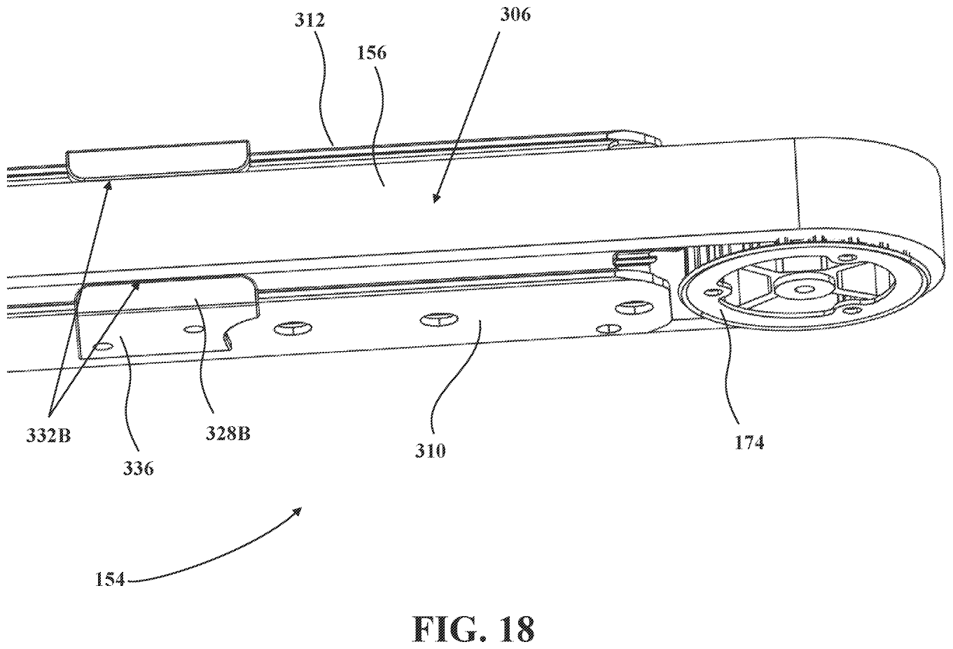

As best shown in FIG. 11 and FIG. 18, in certain implements, the track assembly 154 may include a mid-brace 336 that is separate from the lateral brace 302. When included, the mid-brace 336 is located between the lateral brace 302 and the pully 174. Similar to the lateral brace 302, the mid-brace 336 also abuts at least a portion of the belt 156 to retain the belt 156 in engagement with the roller 172 for limiting lateral movement of the belt 156 relative to the rail 168 occurring in response to force acting on the belt 156 between stairs ST and the roller 172 during operation of the motor 188. Although not required, the mid-brace 336 typically includes a flat region 328B which is similar to the linear region 328 of the lateral-brace 304. The mid-brace 336 typically does not include a curved region 326. The flat region 328B of the mid-brace 336 includes a contact edge 332B that is similar to the leading edge 332 and configured to limit lateral movement of the belt 156 by abutting the belt 156 within the contact region 321. When included, the flat region 328B is typically located about the stair-side 306 of the rail 168.

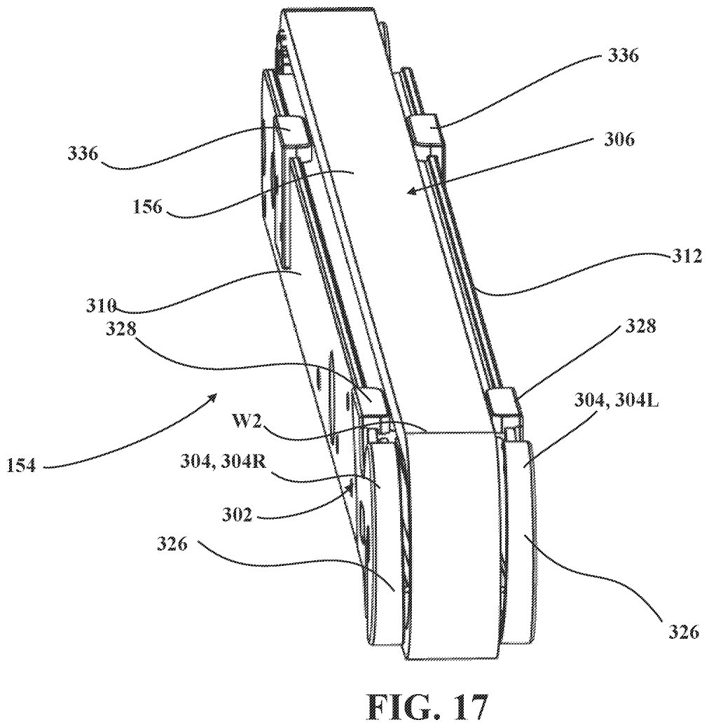

As best shown in FIGS. 11 and 17, in certain implements, the lateral brace 302 is configured to abut the belt 156 along both sidewalls of the rail 168. Generally, in this implementation, the lateral brace 302 defines a right brace 304R and a left brace 304L, with the left brace 304L and the right brace 304R independently configured to abut at least a portion of the belt 156 to retain the belt 156 in engagement with the roller 172 for limiting lateral movement of the belt 156 relative to the rail 168 occurring in response to force acting on the belt 156 between stairs ST and the roller 172 during operation of the motor.

The right brace 304R and the left brace 304L may include each aspect of “the brace 304” described above. For example, the left and right braces 304L, 304R may independently include the curved region 326 configured to retain the belt 156 about the roller 172, and the linear region 328 configured to retain the belt 156 about the rail 168, with the linear region 328 spaced from the roller 172 between the first rail end 168A and the second rail end 168B. Typically, the left and right braces 304L, 304R are mirror images of each other and spaced from each other on opposite sides of the rail 168 with the belt 156 positioned between the right and left braces 304R, 304L. Thus, the distance between the leading edge 332s of the right and left braces 304R, 304L is greater than the width (W2) of the belt 156.

As described above, the patient transport apparatus 100 typically includes two track assemblies 154. In this implementation, each track assembly 154 may include the lateral brace 302. In addition, each track assembly 154 may include the lateral brace 302 defining left and right braces 304L, 304R with the left and right braces 304R, 304L being mirror images of each other.

Several configurations have been discussed in the foregoing description. However, the configurations discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

The present disclosure also comprises the following clauses, with specific features laid out in dependent clauses, that may specifically be implemented as described in greater detail with reference to the configurations and drawings above.

### CLAUSES

I. A patient transport apparatus operable by a user for transporting a patient along stairs, the patient transport apparatus comprising:
a support structure including a rear support assembly having a rear upright defining a support channel;
a seat section and a back section coupled to the support structure for supporting the patient; and
a track assembly extending from the support structure, the track assembly including:
   a rail extending between a first rail end and a second rail end,
   a roller supported for rotation adjacent to the first rail end,
   a motor supporting a pulley for rotation adjacent to the second rail end,
   a belt supported in engagement with the roller and the pulley and arranged for movement relative to the rail in response to torque generated by the motor, and
   a lateral brace operatively attached to the rail and defining a brace configured to abut at least a portion of the belt to retain the belt in engagement with the roller for limiting lateral movement of the belt relative to the rail occurring in response to force acting on the belt between stairs and the roller during operation of the motor.

II. The patient transport apparatus of clause I, wherein the lateral brace is arranged closer to the first rail end than the second rail end.

III. The patient transport apparatus of any of clauses I-II, wherein the belt defines an outer belt surface having a height (H) and further defines a contact region arranged to abut the brace to limit lateral movement of the belt relative to the rail, with the contact region defined as a zone within the belt surface from about 15% to about 85% of the height (H).

IV. The patient transport apparatus of clause III, wherein the outer belt surface also defines an upper region above the contact region, wherein the upper region remains spaced from the brace.

V. The patient transport apparatus of any of clauses III-IV, wherein the brace comprises a curved region configured to retain the belt about the roller, and a linear region configured to retain the belt about the rail, with the linear region spaced from the roller between the first rail end and the second rail end.

VI. The patient transport apparatus of clause V, wherein the curved region and the roller share a common axis.

VII. The patient transport apparatus of clause VI, wherein the roller has a radius RI and the curved region has a radius R2 that is greater than R1.

VIII. The patient transport apparatus of any of clauses V-VII, wherein the curved region and the linear region are spaced from each other by a gap region, with the gap region shaped to avoid contact with the belt between the curved region and the linear region.

IX. The patient transport apparatus of clause VIII, wherein a length of the gap region between the curved region and the linear region is greater than the height (H) of the belt.

X. The patient transport apparatus of any of clauses V-IX, wherein the roller defines a belt contact surface having a width W1 and the belt defines a width W2 that is less than the width W1.

XI. The patient transport apparatus of any of clauses V-X, wherein the rail includes a stair-side oriented towards the stairs during operation and a non-contact side opposite the stair-side, and wherein the linear region is configured to abut the belt about the stair-side.

XII. The patient transport apparatus of clause XI, wherein the brace includes a leading edge configured to abut the belt along the curved region and the linear region, wherein the leading edge of the linear region is located along the stair-side of the rail.

XIII. The patient transport apparatus of clause XII, wherein the leading edge of the curved region tapers laterally towards the belt.

XIV. The patient transport apparatus of clause XIII, wherein a distance between the leading edge of the curved region and the belt is at a minimum about the stair-side of the rail.

XV. The patient transport apparatus of any of clauses I-XIV, further comprising a mid-brace separate from the lateral brace, the mid-brace configured to abut at least a portion of the belt to retain the belt in engagement with the roller for limiting lateral movement of the belt relative to the rail occurring in response to force acting on the belt between stairs and the roller during operation of the motor.

XVI. A patient transport apparatus operable by a user for transporting a patient along stairs, the patient transport apparatus comprising:
a support structure including a rear support assembly having a rear upright defining a support channel;
a seat section and a back section coupled to the support structure for supporting the patient; and
a track assembly extending from the support structure, the track assembly including:
   a rail extending between a first rail end and a second rail end,
   a roller supported for rotation adjacent to the first rail end,
   a motor supporting a pulley for rotation adjacent to the second rail end,
   a belt supported in engagement with the roller and the pulley and arranged for movement relative to the rail in response to torque generated by the motor, and
   a lateral brace operatively attached to the rail and defining a right brace and a left brace, with each brace configured to abut at least a portion of the belt to retain the belt in engagement with the roller for limiting lateral movement of the belt relative to the rail occurring in response to force acting on the belt between stairs and the roller during operation of the motor.

XVII. The patient transport apparatus of clause XVI, wherein the left and right braces are spaced from each other on opposite sides of the rail, with the belt positioned between the left and right braces.

XVIII. The patient transport apparatus of any of clauses XVI-XVII, wherein the lateral brace is arranged closer to the first rail end than the second rail end.

XIX. The patient transport apparatus of any of clauses XVI-XVIII, wherein the belt defines an outer belt surface having a height (H) and further defines a contact region arranged to abut the brace to limit lateral movement of the belt relative to the rail, with the contact region defined as a zone within the outer belt surface from about 15% to about 85% of the height (H).

XX. The patient transport apparatus of clause XIX, wherein the outer belt surface also defines an upper region above the contact region, wherein the upper region remains spaced from the brace.

XXI. The patient transport apparatus of any of clauses XIX-XX, wherein the left and right braces independently comprise a curved region configured to retain the belt about the roller, and a linear region configured to retain the belt about the rail, with the linear region spaced from the roller between the first rail end and the second rail end.

XXII. The patient transport apparatus of clause XXI, wherein the curved region of the left brace, the curved region of the right brace, and the roller share a common axis.

XXIII. The patient transport apparatus of clause XXII, wherein the roller has a radius R1 and the curved region of the left brace and the curved region of the right brace, each have a radius R2 that is greater than R1.

XXIV. The patient transport apparatus of any of clauses XXI-XXIII, wherein the roller defines a belt contact surface having a width W1 and the belt defines a width W2 that is less than the width W1.

XXV. The patient transport apparatus of any of clauses XXI-XXIV, wherein the rail includes a stair-side oriented towards the stairs during operation and a non-contact side opposite the stair-side, and wherein the linear region of the left brace and the linear region of the right brace are configured to abut the belt about the stair-side.

XXVI. The patient transport apparatus of clause XXV, wherein the left and right braces independently include a leading edge configured to abut the belt along the curved region and the linear region of each brace, wherein the leading edges of the linear regions of the left and right braces are located along the stair-side of the rail.

XXVII. The patient transport apparatus of any of clauses XXIV-XXVI, wherein a leading edge of the curved region of the left brace and a leading edge of the curved region of the right brace are spaced from each other by a distance (D) that is greater than the width of the belt (W2).

XXVIII. The patient transport apparatus of clause XXVII, wherein the leading edge of the curved region of the left brace and the leading edge of the curved region of the right brace each independently taper laterally towards the belt.

XXIX. The patient transport apparatus of any of clauses XVI-XXVIII, further comprising a mid-brace separate from the lateral brace, the mid-brace configured to abut at least a portion of the belt to retain the belt in engagement with the roller for limiting lateral movement of the belt relative to the rail occurring in response to force acting on the belt between stairs and the roller during operation of the motor.

XXX. The patient transport apparatus of any of clauses XVI-XXIX, wherein the right and left braces are mirror images of each other.

What is claimed is:

1. A patient transport apparatus operable by a user for transporting a patient along stairs, the patient transport apparatus comprising:
a support structure including a rear support assembly having a rear upright defining a support channel;
a seat section and a back section coupled to the support structure for supporting the patient; and
a track assembly extending from the support structure, the track assembly including:
a rail extending between a first rail end and a second rail end,
a roller supported for rotation adjacent to the first rail end,
a motor supporting a pulley for rotation adjacent to the second rail end,
a belt supported in engagement with the roller and the pulley and arranged for movement relative to the rail in response to torque generated by the motor, and
a lateral brace operatively attached to the rail and defining a brace configured to abut at least a portion of the belt to retain the belt in engagement with the roller for limiting lateral movement of the belt relative to the rail occurring in response to force acting on the belt between stairs and the roller during operation of the motor.

2. The patient transport apparatus of claim 1, wherein the lateral brace is arranged closer to the first rail end than the second rail end.

3. The patient transport apparatus of claim 1, wherein the belt defines an outer belt surface having a height (H) and further defines a contact region arranged to abut the brace to limit lateral movement of the belt relative to the rail, with the contact region defined as a zone within the outer belt surface from about 15% to about 85% of the height (H).

4. The patient transport apparatus of claim 3, wherein the outer belt surface also defines an upper region above the contact region, wherein the upper region remains spaced from the brace.

5. The patient transport apparatus of claim 3, wherein the brace comprises a curved region configured to retain the belt about the roller, and a linear region configured to retain the belt about the rail, with the linear region spaced from the roller between the first rail end and the second rail end.

6. A patient transport apparatus operable by a user for transporting a patient along stairs, the patient transport apparatus comprising:
a support structure including a rear support assembly having a rear upright defining a support channel;
a seat section and a back section coupled to the support structure for supporting the patient; and
a track assembly extending from the support structure, the track assembly including:
a rail extending between a first rail end and a second rail end,
a roller supported for rotation adjacent to the first rail end,
a motor supporting a pulley for rotation adjacent to the second rail end,
a belt supported in engagement with the roller and the pulley and arranged for movement relative to the rail in response to torque generated by the motor, and
a lateral brace operatively attached to the rail and defining a right brace and a left brace, with each brace configured to abut at least a portion of the belt to retain the belt in engagement with the roller for limiting lateral movement of the belt relative to the rail occurring in response to force acting on the belt between stairs and the roller during operation of the motor.

7. The patient transport apparatus of claim 6, wherein the left and right braces are spaced from each other on opposite sides of the rail, with the belt positioned between the left and right braces.

8. The patient transport apparatus of claim 6, wherein the lateral brace is arranged closer to the first rail end than the second rail end.

9. The patient transport apparatus of claim 6, wherein the belt defines an outer belt surface having a height (H) and further defines a contact region arranged to abut the brace to limit lateral movement of the belt relative to the rail, with the contact region defined as a zone within the outer belt surface from about 15% to about 85% of the height (H).

10. The patient transport apparatus of claim 9, wherein the outer belt surface also defines an upper region above the contact region, wherein the upper region remains spaced from the brace.

11. The patient transport apparatus of claim 9, wherein the left and right braces independently comprise a curved region configured to retain the belt about the roller, and a linear region configured to retain the belt about the rail, with the linear region spaced from the roller between the first rail end and the second rail end.

12. The patient transport apparatus of claim 11, wherein the curved region of the left brace, the curved region of the right brace, and the roller share a common axis.

13. The patient transport apparatus of claim 12, wherein the roller has a radius R1 and the curved region of the left brace and the curved region of the right brace, each have a radius R2 that is greater than R1.

14. The patient transport apparatus of claim 11, wherein the roller defines a belt contact surface having a width W1 and the belt defines a width W2 that is less than the width W1.

15. The patient transport apparatus of claim 11, wherein the rail includes a stair-side oriented towards the stairs during operation and a non-contact side opposite the stair-side, and wherein the linear region of the left brace and the linear region of the right brace are configured to abut the belt about the stair-side.

16. The patient transport apparatus of claim 15, wherein the left and right braces independently include a leading edge configured to abut the belt along the curved region and the linear region of each brace, wherein the leading edges of the linear regions of the left and right braces are located along the stair-side of the rail.

17. The patient transport apparatus of claim 14, wherein a leading edge of the curved region of the left brace and a leading edge of the curved region of the right brace are spaced from each other by a distance (D) that is greater than the width of the belt (W2).

18. The patient transport apparatus of claim 17, wherein the leading edge of the curved region of the left brace and the leading edge of the curved region of the right brace each independently taper laterally towards the belt.

19. The patient transport apparatus of claim 6, further comprising a mid-brace separate from the lateral brace, the mid-brace configured to abut at least a portion of the belt to retain the belt in engagement with the roller for limiting lateral movement of the belt relative to the rail occurring in response to force acting on the belt between stairs and the roller during operation of the motor.

20. The patient transport apparatus of claim 6, wherein the right and left braces are mirror images of each other.
